(19) United States
(12) Patent Application Publication
(10) Pub. No.: US 2012/0297156 A1
(43) Pub. Date: Nov. 22, 2012

(54) STORAGE SYSTEM AND CONTROLLING METHOD OF THE SAME

(75) Inventors: Tomohiko Suzuki, Odawara (JP); Keiichi Tezuka, Yokohama (JP); Akitatsu Harada, Tama (JP)

(73) Assignee: HITACHI, LTD., Tokyo (JP)

(21) Appl. No.: 13/133,095

(22) PCT Filed: May 20, 2011
(86) PCT No.: PCT/JP2011/002823

§ 371 Date: Jun. 6, 2011

(51) Int. Cl. G06F 12/02; G06F 12/16

(52) U.S. Cl. 711/162; 711/E12.002; 711/E12.103

(57) ABSTRACT

A storage system comprising a first storage apparatus, a second storage apparatus, each storing data processed by an external apparatus, each of the first and second apparatuses including a pool of a plurality of unit physical storage areas for storing the data, the unit physical storage areas being classified into a plurality of storage tiers, a logical storage area in the first storage apparatus and the logical storage area in the second storage apparatus respectively including one or more of the storage tiers that are assigned to the respective logical storage areas, the storage system holding storage tier construction information of the first storage apparatus, and a data migration controller, when the data stored in the first storage apparatus are migrated to the second storage apparatus, transferring the storage tier construction information of the first storage apparatus to the second storage apparatus.

### TECHNICAL FIELD

The present invention relates to a storage system and a method of controlling the same.

### BACKGROUND ART

For a storage system providing a data storage area to an external device such as a business-application server, increase of a storage capacity for the data storage area is being demanded in accordance with recent increase in size of data to be stored. Usually, the capacity required for the data storage area gradually increases since an operation of a storage system has been started. Therefore, provision of a storage device of large capacity with the storage system at an initial stage of operation which leads to excess initial investment is not preferable to a storage system service provider.

From this point of view, a capacity virtualization technology, that is, virtualization of a data storage area created in a storage system which enables efficient and economical use of a storage device by allocating physical data storage area of the storage device when supply of the data storage area is demanded for actual use by an external device is being utilized. In the capacity virtualization technology, a logical storage volume having a virtual storage capacity independent to an actual physical capacity of the storage device is defined as a virtual volume, and the external device recognizes the virtual volume as a data storage area. The capacity virtualization technology is usually called “Thin Provisioning.”

On the other hand, considering a mode of using a storage system by an external device, there is provided a data storage area storing active data to which frequent read/write is carried out, as well as a storage area of less access frequency to which only backup data is periodically written. In view of this mode of using data storage areas, a technology of hierarchical allocation of a variety of storage devices constituting the virtual volume is being utilized. In this technology, for example, the expensive storage device of higher data IO performance is allocated to a data storage area of higher access frequency, and the inexpensive storage device of lower data IO performance is allocated to the data storage area of lower access frequency. This hierarchization technology achieves optimization of a performance of a storage system and facilitation of management of operation of the storage system through arrangement of data in a virtual volume into a plurality of tiers according to the types of the storage device.

With respect to the above capacity virtualization and hierarchization technologies, the techniques as disclosed in PTL1-PTL4 are proposed. The technique in PTL1 discloses evaluating a value and/or a characteristic such as an access frequency of data for each segment of a logical storage area and migrating the data stored in an actual storage area, i.e., the storage area in which a piece of actual data is stored, between the plurality of the actual storage areas respectively having different characteristics according to the evaluation result. It is described that according to the technique the storage tiers can be managed according to the characteristic of the data stored in the segment, for each of the segments constituting a logical volume.

Further, in an operation of a storage system, it is sometimes required to migrate data between a plurality of storage apparatuses according to necessity from the operation such as replacement of the storage apparatus. PTL2 discloses a technique in which pieces of data are migrated from the storage apparatus of migration source to the storage apparatus of migration target without interrupting access to data in a storage apparatus from a host computer and continuously securing availability of the data from the host computer after the migration.

Further, PTL3 discloses a technique of migrating data between storage apparatuses while maintaining hierarchy among files in the storage system having a plurality of storage areas for files which are hierarchized according to the file specific characteristics.

PTL4 proposes a technique in copying a file between storage systems transmitting class information of the file to be copied to the storage system of copy target and storing the file in the copy target storage system in a hierarchical structure corresponding to the storing type of the files in the copy source storage system.

### CITATION LIST

### Patent Literature

PTL 1: U.S. Patent Application Publication No. 2009/0070541
PTL 2: Japanese Patent Application Laid-open Publication No. 2008-176627
PTL 3: Japanese Patent Application Laid-open Publication No. 2008-15984
PTL 4: Japanese Patent Application Laid-open Publication No. 2007-265403

### SUMMARY OF INVENTION

### Technical Problem

However, none of PTL1-PTL4 discloses a technique in which, when copying/migrating data stored in a virtual volume employing hierarchization technique for a data storage area to a virtual volume in a different storage apparatus, tier arrangement information at the storage apparatus of the copy/migration source is transferred to the storage apparatus of the copy/migration target to be used in the same.

The present invention has been made in order to solve the above and other problems, and one object of the same is to provide a storage system and a control method of the storage system providing a data storage area which is virtualized in storage capacity and has hierarchized structure according to types of storage devices, the storage device and the control method of the same enabling data copying and/or data migration between different storage apparatuses while taking the hierarchical structure of the storage area into consideration.

### Solution to Problem

One aspect of the present invention for achieving the above and other objects is a storage system comprising a first storage apparatus, a second storage apparatus, each of the first and second apparatuses including a logical storage area for storing data processed by an external apparatus, each of the first and second apparatuses including a pool of a plurality of unit physical storage areas constructing a physical storage area for providing the logical storage area for storing the data, the unit physical storage areas being classified into a plurality of storage tiers according to storage area property information for characterizing each of the unit physical storage areas, the logical storage area in the first storage apparatus and the logical storage area in the second storage apparatus respectively including one or more of the storage tiers that are assigned to the respective logical storage areas according to the unit physical storage areas correlated to the respective logical storage areas, the storage system holding storage tier construction information that is information of construction of the storage tier in the logical storage area of the first storage apparatus, and a data migration controller, when the data stored in the logical storage area of the first storage apparatus are migrated to the logical storage area of the second storage apparatus, transferring the storage tier construction information of the first storage apparatus to the second storage apparatus so as to reflect the construction of the storage tier in the logical storage area of the first storage apparatus in the second storage apparatus.

### Advantageous Effects of Invention

According to the one aspect of the present invention, in a storage system and a control method of the storage system providing a data storage area which is virtualized in storage capacity and has hierarchized structure according to types of storage devices, data copying and/or data migration between different storage apparatuses while taking the hierarchical structure of the storage area into consideration is realized.

### BRIEF DESCRIPTION OF DRAWINGS

FIG. 1 is a figure showing a connection construction of a storage system 1 according to one embodiment of the present invention.

FIG. 2 is a figure showing an example of a construction of a computer 10.

FIG. 3 is a figure showing an example of a construction of a storage apparatus

FIG. 4 is a figure showing an example of a software construction of a management server 100.

FIG. 5 is a figure showing an example of a software construction of a service server 200.

FIG. 6 is a figure showing an example of a software construction of a storage apparatus 300.

FIG. 7 is a schematic diagram showing a construction of a virtual volume in the storage apparatus 300.

FIG. 8 is a figure showing an example of a pair configuration information table 105.

FIG. 9 is a figure showing an example of a tier arrangement policy information table 306.

FIG. 10 is a figure showing an example of a policy table 307.

FIG. 11 is a figure showing an example of a LUN correspondence information table 106.

FIG. 12 is a figure showing an example of a usage correspondence information table 107.

FIG. 13 is a figure describing an automatic option setting process for the pair configuration information table 105.

FIG. 14 is a figure showing an example of the automatic option setting process flow for the pair configuration information table 105.

FIG. 15 is a figure describing a volume copy process from a primary site to a secondary site.

FIG. 16 is a figure showing an exemplary flow of a volume copy process from a primary site to a secondary site.

FIG. 17 is a figure describing a recovery process from a secondary site to a primary site.

FIG. 18A is a figure showing an exemplary flow of a recovery process from a secondary site to a primary site.

FIG. 18B is a figure showing an exemplary flow of a recovery process from a secondary site to a primary site.

FIG. 18C is a figure showing an exemplary flow of a recovery process from a secondary site to a primary site.

FIG. 19 is a figure describing a data restoration process at a secondary site.

FIG. 20 is a figure showing an exemplary flow of a data restoration process at a secondary site.

FIG. 21 is a figure describing a process of migration of a virtual volume.

FIG. 22A is a figure showing an exemplary flow of a process of migration of a virtual volume.

FIG. 22B is a figure showing an exemplary flow of a process of migration of a virtual volume.

FIG. 23 is a figure showing an exemplary flow of a process of determining a tier arrangement for data from a data copy source at a data copy target.

FIG. 24 is a figure describing a backup-recovery process.

FIG. 25A is a figure showing an exemplary flow of a backup-recovery process.

FIG. 25B is a figure showing an exemplary flow of a backup-recovery process.

FIG. 26 is a figure describing a migration process.

FIG. 27A is a figure showing an exemplary flow of a migration process.

FIG. 27B is a figure showing an exemplary flow of a migration process.

### DESCRIPTION OF EMBODIMENTS

The embodiments for carrying out the present invention will be described hereinbelow, as referring to the appended drawings. It is to be noted that the functions of various programs to be mentioned below are realized by a CPU or a processor which reads the programs from memory and executes the same as referring to information stored in various management tables.

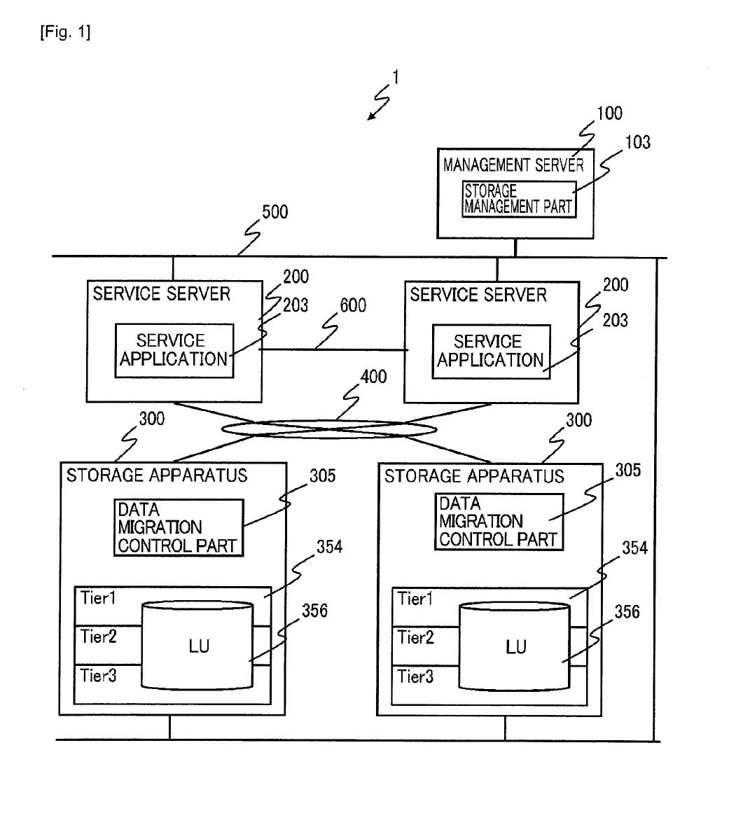

Firstly, a construction of a storage system 1 according to an embodiment of the present invention will be described. FIG. 1 shows an example of connection configuration of the storage system 1. The storage system 1 includes a management server 100, 2 units of service servers 200, and 2 units of storage apparatuses 300.

The service servers 200 and the storage apparatuses 300, each of which providing a data storage area for the data processed by the service server 200, are coupled with a first communication network 400 communicatively to each other. The first communication network 400 is, for example, a SAN (Storage Area Network) constructed using a Fibre Channel protocol (FC protocol). The first communication network 400 provides a data path for a data IO between the service servers 200 and the storage apparatuses 300 as well as a data 10 between the storage apparatuses 300 for a data copy, a migration and so on therebetween.

The management server 100, the service servers 200 and the storage apparatuses 300 are coupled with a second communication network 500 communicatively to each other. The second communication network 500 is constructed as, for example, a LAN (Local Area Network). The second communication network 500 provides a data path for collecting configuration information and/or performance information from the service servers 200 and the storage apparatuses 300 by the management server 100 and transmitting of management information to the service servers 200 and the storage apparatuses 300 from the management server 100 using a communication protocol considered appropriate.

The service servers 200 are coupled with a third communication network 600 communicatively to each other. The third communication network 600 may be constructed as a communication network as the second communication network 500, for example, and prepares a data path for a data communication for services between the service servers 200. It is to be noted that FIG. 1 as an example illustrates the storage system 1 including the two service servers 200, however, a single service server 200, or three or more service servers 200 may be coupled in the storage system 1.

It is also to be noted the main constructional elements of the management server 100, the service server 200 and the storage apparatus 300 will be described later, which are shown to facilitate understanding of the construction of the present embodiment.

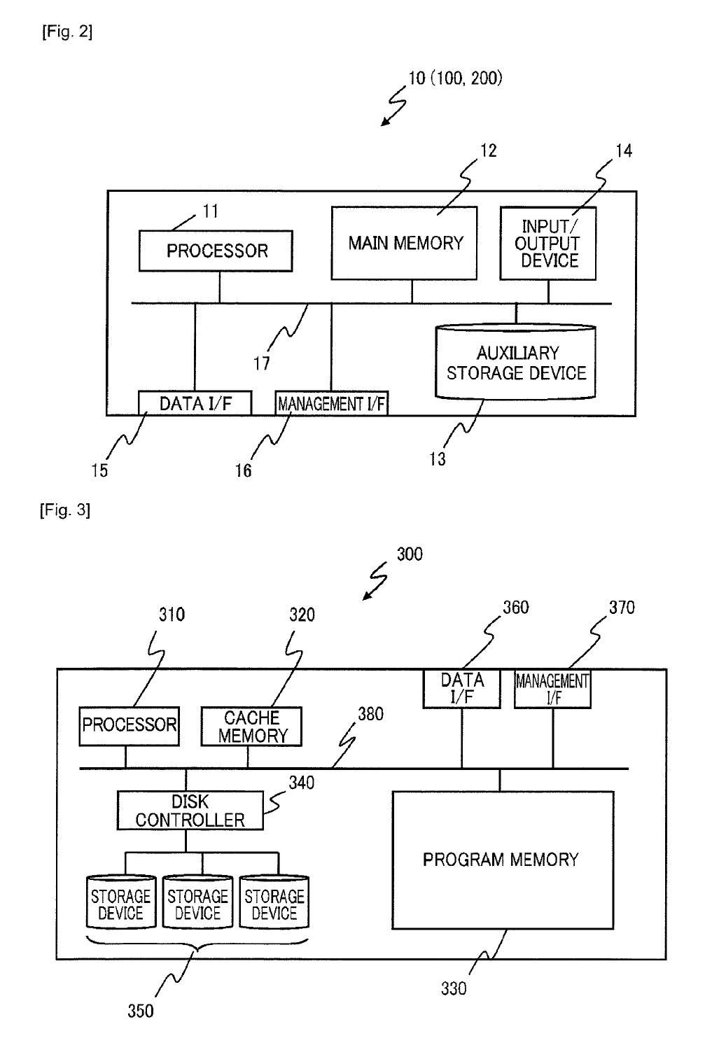

Then, a hardware configuration of the management server 100 and the service server 200 will be described. FIG. 2 shows an exemplary construction of a computer 10 which can be used as the management server 100 or the service server 200. The computer 10 includes a processor 11 such as a CPU (Central Processing Unit), MPU (Micro Processing Unit), or the like, a main memory 12, an auxiliary storage apparatus 13, an input/output device 14, a data interface (data UF) 15, a management interface (management I/F) 16, and an internal communication network 17 which communicatively couples the processor 11 to the management I/F 16 to each other.

The main memory 12 is constructed with a volatile memory device including semiconductor memory such as a RAM (Random Access Memory) and a ROM (Read Only Memory), for example. The auxiliary storage device 13 may be constructed with a writable/readable non-volatile storage device such as a hard disk drive (HDD), an SSD (Solid State Drive) or a read-only non-volatile storage device such as magneto optical media, and the like.

The input/output device 14 may be constructed with an output device including a display device such as a CRT display and an LCD display, and an input device such as a keyboard, a mouse, and/or a tablet. The data I/F 15 and the management I/F 16 are communication interface units respectively coupled with the first communication network 400 and the second communication network 500. Examples of the data I/F 15 and the management I/F 16 are an HBA (Host Bus Adapter) and a NIC (Network Interface Card), respectively. It is to be noted the data UF 15 may be omitted when the computer 10 is used as the management server 100. It is also to be noted a service interface as a communication interface unit equivalent to the management I/F 16 may be provided when the computer 10 is used as the service server 200.

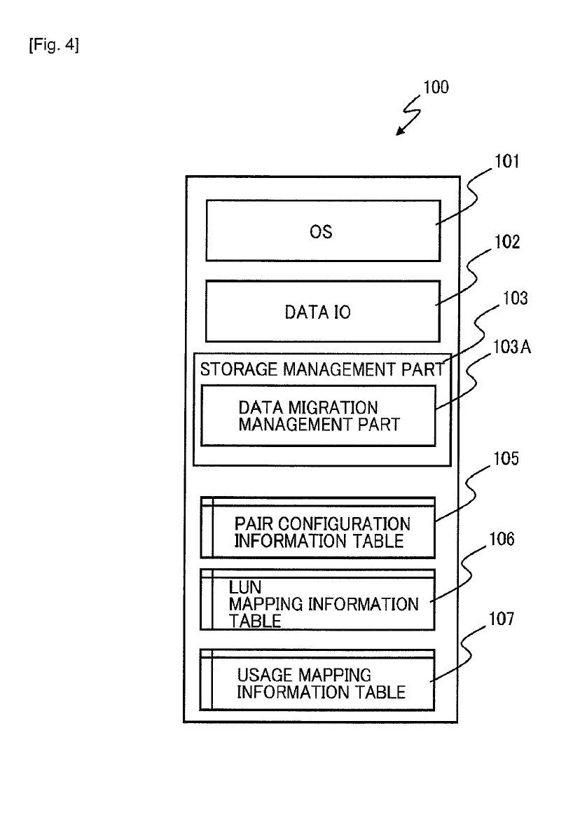

Then, a hardware configuration of the storage apparatus 300 will be described. FIG. 3 shows an exemplary hardware construction of the storage apparatus 300. The storage apparatus 300 includes a processor 310 such as a CPU or an MPU, a cache memory 320, a program memory 330, a disk controller 340, a storage device 350, a data I/F 360, a management I/F 370, and an internal communication network 380 communicatively coupling the processor 310 to the management I/F 370 to each other.

The cache memory 320 provides a storage area for temporarily storing data to be written to the storage device 350 from the external apparatus such as the service server 200 and data read from the storage device 350. The cache memory 320 is constructed with a semiconductor memory device such as a RAM. The program memory 330 includes a storage area for storing programs for implementing the functions of the storage apparatus 300 of the present embodiment and various data to be used by the programs. The program memory 330 is constructed with a semiconductor memory device such as a RAM.

The disk controller 340 is a control unit for processing data IO received from an external device such as the service server 200. The disk controller 340 controls data writing and data reading between the cache memory 320 and the storage device 350, for example. The storage device 350 can be constructed with a readable/writable non-volatile storage device such as an HDD, an SSD, or a magnetic tape apparatus. As will be described later, a virtual volume which is a logical storage area virtualized by a RAID control and a virtualization control, is provided to the external apparatus.

The data I/F 360 and the management I/F 370 are communication interface units respectively coupled with the first communication network 400 and the second communication network 500, as the data I/F 15 and the management I/F 16 in the computer 10. It is to be noted, though not illustrated in the construction in FIG. 3, the storage apparatus 300 may be provided with a component corresponding to the input/output device 14 of the computer 10.

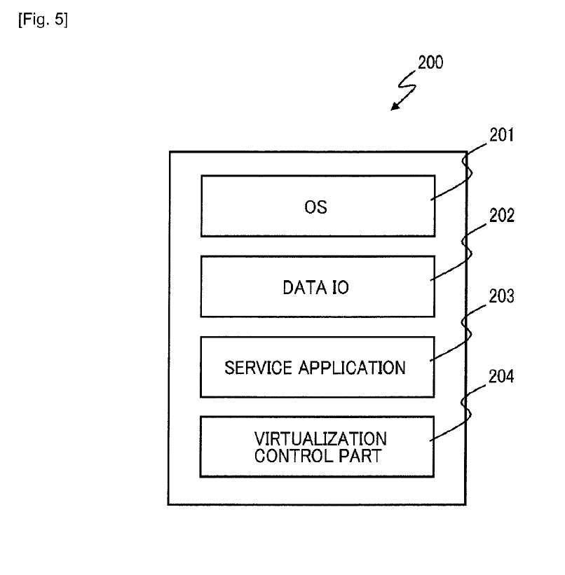

Then, respective software configurations of the management server 100, the service server 200, and the storage apparatus 300 will be described. FIGS. 4-6 show the software configurations of the management server 100, the service server 200, and the storage apparatus 300 of the present embodiment respectively.

First, a description of the management server 100 will be given. The management server 100 has functional parts including an operating system (OS) 101, a data IO part 102, and a storage management part 103 with a data migration management part 103A. The OS 101, the data 10 part 102, and the storage management part 103 are stored in the auxiliary storage device 13 and are read out into the main memory 12 and executed by the processor 11.

The OS 101 is software implementing a fundamental function of the computer 10 as the management server 100 such as a data input/output processing and a memory management processing. Any OS which is suitable may be selected and used as the OS 101 from among those used for a general computer 10. The data IO part 102 carries out a data input/output processing through the input/output device 14, the data I/F 15, and the management I/F 16 under control by the OS 101.

The storage management part 103 receives general operational instructions on management through the input/output device 14 and transmits the instructions to the storage apparatus 300. The storage management part 103 also has a function of monitoring an operation of the storage apparatus 300 with an SNMP (Small Network Monitoring Protocol), for example. In the present embodiment, the data migration management part 103A is provided as a part of the storage management part 103. The data migration management part 103A has such functions as a data backup processing, a data copy processing performed in the data backup processing, a data recovery processing, and the like, and a data migration processing, which are carried out in each of the storage apparatus 300. More specifically, the data migration management part 103A transmits to the respective storage apparatuses 300 through the second communication network 500 the instructions on the data migration processing accompanying the data processings such as the data backup processing and the data recovery processing.

Next, the tables held in the management server 100 will be described. As shown in FIG. 4, the management server 100 holds a pair configuration information table 105, an LUN mapping information table 106, and a usage mapping table 107 in the main memory 12 of the computer 10, for example.

The pair configuration information table 105 records information on a pair of the virtual volumes, the virtual volumes being provided in the storage apparatuses 300 formed in different cabinets respectively. The data migration processing is carried out between the virtual volumes in which a pair relationship is defined. The pair configuration information table 105 will be further described referring to the exemplary configuration. It is to be noted the virtual volume will be mentioned as an LU (Logical Unit) hereinbelow.

The LUN mapping information table 106 stores correspondence between the external apparatus such as the service server 200 and the LU providing a data storage area used by the external apparatus. The LUN mapping information table 106 will be further described referring to the exemplary configuration.

The usage mapping information table 107 records correspondence between the program such as a service application using the LU from the external device and a usage of the LU. The usage mapping information table 107 will be further described referring to the exemplary configuration.

Then, the service server 200 will be described. The service server 200 has the respective operational parts including an OS201, a data 10 part 202, a service application 203, and a virtualization control part 204. Similarly to the management server 100, the OS201, the data IO part 202, the service application 203, and the virtualization control part 204 are stored in the auxiliary storage device 13 of the computer 10, for example, and are read out into the main memory 12 and executed by the processor 11.

The OS 201 and the data IO part 202 are similar to the OS 102 and the data IO part 102 of the management sever 100.

The service application 203 operating on the OS 201 in the service server 200, is an application program carrying out a data processing regarding the services provided by the service server 200. The service application 203 uses the LU provided by the storage apparatus 300 as the data storage area.

The virtualization control part 204 is a program for server virtualization operating on the OS 201 and implements a function of creating one or more virtual servers and allows them to operate on the service server 200 as a physical entity. The server virtualization program may be selected and used from among the existing similar programs, which is considered appropriate. Optionally, the virtualization control part 204 may be omitted from the service server 200.

Next, the storage apparatus 300 will be described. The storage apparatus 300 is provided with respective functional parts including an OS 301, a virtual volume control part 302, a tier arrangement control part 303, and a data migration control part 305. The OS 301, the virtual volume control part 302, the tier arrangement control part 303, and the data migration control part 305 are stored in the program memory 330, for example, and are read out and executed by the processor 310. The OS 301 is the same as the OS 102 of the management server 100, for example.

The virtual volume control part 302 creates a page as a unit physical storage area from the physical storage area provided by the storage device 305 of the storage apparatus 300. The virtual volume control part 302 has a function of volume virtualization in which a logical storage area is created by allocation of the unit physical storage area such as a page to a virtual volume as necessary upon receipt of a data write request from an external apparatus such as the service server 200.

The tier arrangement control part 303 has a function of hierarchization of a virtual volume (LU) created by the virtual volume control part 302 according to the types of the storage devices 350 which is a source of pages to be allotted to the virtual volume. The functions of the virtual volume control part 302 and the tier arrangement control part 303 will be described later more particularly.

The data migration control part 305 carries out a data migration process between the storage apparatuses 300 or in the respective storage apparatuses 300 and the other processes accompanying the same in the processes of the storage system 1 of the present embodiment. The processes by the data migration control part 305 will be described later referring to the examples of the respective data process flows.

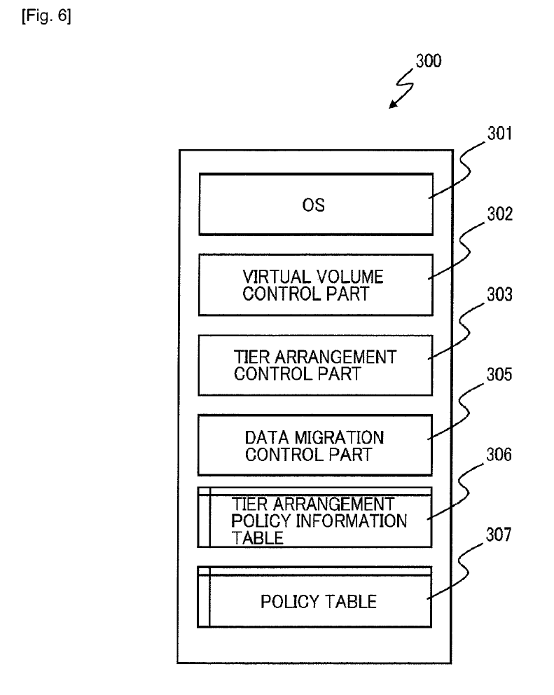

Next, the tables held in the storage apparatus 300 will be described. As shown in FIG. 6, the tier arrangement policy information table 306 and the policy table 307 are stored, for example, in the program memory 330 of the storage apparatus 300.

The tier arrangement policy information table 306 is a table indicating location of information of hierarchization policy set for an LU. The policy table 307 stores contents of the policy set in the hierarchization policy indicated by the tier arrangement policy information table 306. The tier arrangement policy information table 306 and the policy table 307 will be described later referring to the examples of the respective configurations.

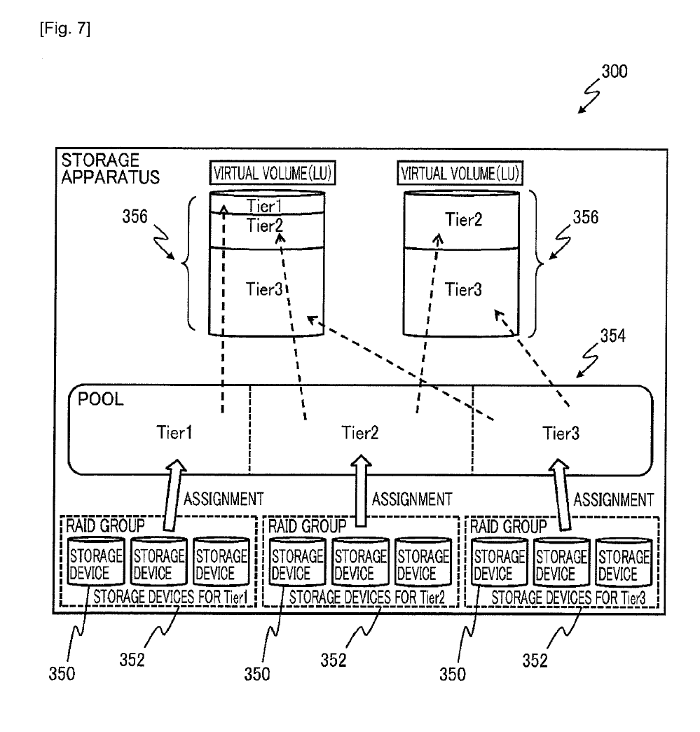

Next, the configurations of a volume virtualization process and a hierarchization process in the storage apparatus 300 of the present embodiment will be described. FIG. 7 schematically shows a configuration of the virtual volume in the storage apparatus 300. The storage device 350 are classified according to their types into 3 RAID groups 352, the respective ones of which being allotted to Tier1, Tier2, and Tier3. In the example shown in FIG. 7, Tier1 is configured with a storage device which is expensive but of the best data IO performance, for example, a SSD. Subsequently, the storage devices which are inexpensive but of relatively low performance are allotted to Tier2 and Tier3. For example, the HDD with a SAS (Serial Attached SCSI) interface is used for Tier2, and the HDD with a SATA (Serial ATA) interface is used for Tier3. The RAID groups 352 using the respective storage devices 350 may be created with a typical RAID control function provided, for example, with the disk controller 340 of the storage apparatus 300 according to appropriate RAID levels.

The physical storage area of each of the RAID groups 352 is allotted to each of the tiers in the pool 354 by the page as a unit physical storage area by the virtual volume control part 302. In other words, the pool 354 is a group of the pages classified into the tiers, Tier1-Tier3. The virtual volume control part 302 creates a virtual volume (LU) for providing a logical storage area to an external apparatus such as the service server 200. Here, the tier arrangement control part 303 allots to the LU 356 a page or pages of a required storage capacity according to a data write request from an external apparatus such as the service server 200. More particularly, the tier arrangement control part 303 allots to the LU 356 any of the areas from the pool 354 including Tier1 of relatively higher performance to Tier3 of relatively lower performance according to an access frequency which is a frequency of an access to each of the pages in the LU 356 from the service application 203 and the like operating in an external apparatus such as the service server 200. As the access frequency regarding the service application 203 changes, the tier from which the page is allotted to the LU 356 is dynamically changed.

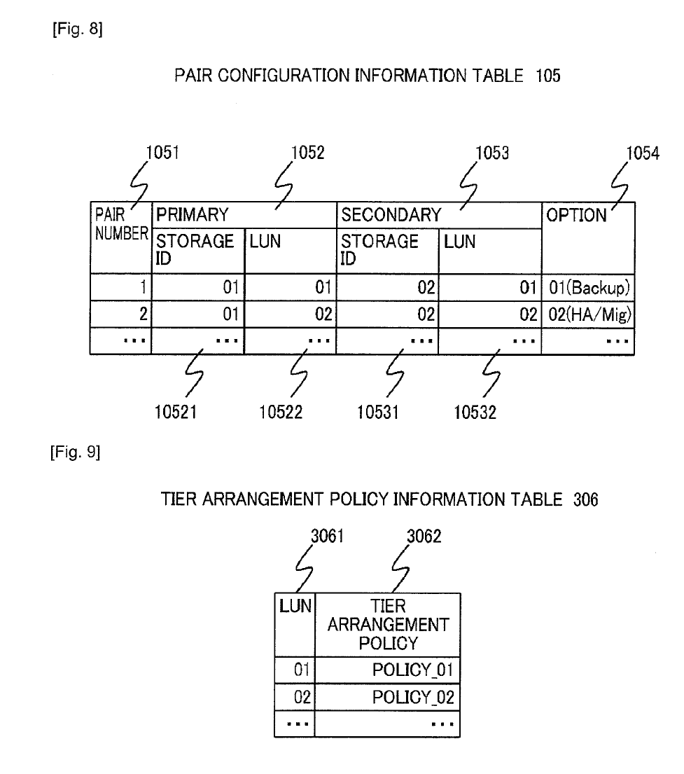

Next, the configuration of each of the tables will be described. FIG. 8 shows an example of the pair configuration information table 105. The pair configuration information table 105 records the items of a pair number 1051, a primary 1052, a secondary 1053, and an option 1054 in a mutually correlated manner. The pair number 1051 is a number affixed to a pair of LUs, simply referred to as a “pair” hereinbelow, the pair being constructed by the LUs 356 provided in the two units of the storage apparatuses 300 respectively, so as to identify each of the pairs. The primary 1052 shows that the LU 356 identified by a storage ID 10521 as an identification code of the storage apparatus 300 and an LUN 10522 included as subitems is a primary LU which ordinarily accepts data IOs from the service server 200.

In the item of the secondary 1053, a storage ID 10531 and a LUN 10532 are recorded. The storage ID 10531 and the LUN 10532 indicate the LU 356 being a target of data migration such as a data copy process, migration process, and the like performed from the LU 356 as recorded in the primary 1052 when such a process as data backup is carried out. The option 1054 defines a usage of the pair with a code appropriately defined, the pair being the LU 356 identified with the corresponding pair number 1051. In the example in FIG. 8, the item “01(Backup)” indicates the usage is data backup, and the data are allocated in the lowest tier in the secondary LU, notwithstanding a tier arrangement policy to be later described. The option 1054 which reads “02(HA/Mig)” indicates the usage of the pair of the LUs 356 identified with the corresponding pair number 1051 is a migration for securing availability, i.e., “High Availability Migration.” In this case, the data are allocated in the secondary LU according to the tier arrangement policy.

Next, the tier arrangement policy information table 306 will be described. FIG. 9 shows an example of the tier arrangement policy information table 306. The tier arrangement policy information table 306 records an LUN 3061 and a tier arrangement policy 3062 in a mutually correlated manner. The LUN 3061 is an identification number assigned to each of the LUs 356, which is similar to the LUN 10522, 10532 in the pair configuration information table 105. The tier arrangement policy 3062 records an identification code for identifying the tier arrangement policy set for the LU 356 identified with the corresponding LUN 3061.

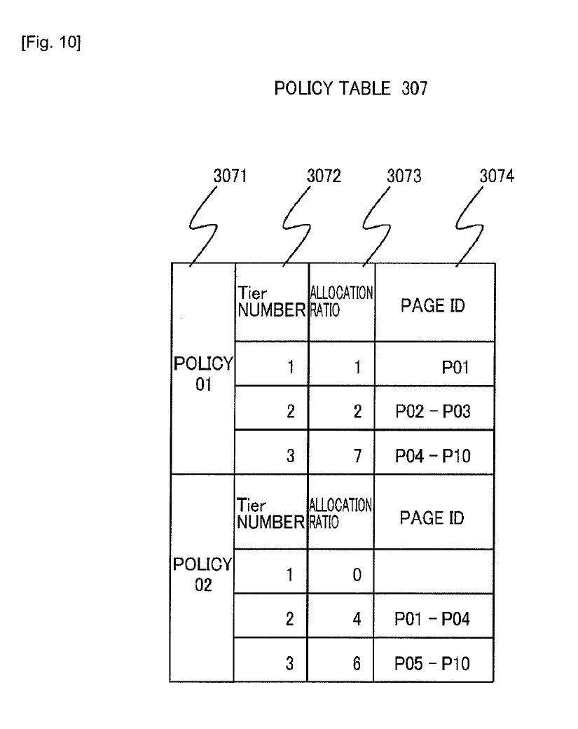

Next, the policy table 307 will be described. FIG. 10 shows an example of the policy table 307. The policy table 307 records a tier arrangement policy 3071, a tier number 3072, an allocation ratio 3073, and a page ID 3074 in a mutually correlated manner. The tier arrangement policy 3071 corresponds to the tier arrangement policy 3062 in the tier arrangement policy information table 306. The tier number 3072 is an identification number assigned to each of the tiers defined in the LU 356. The allocation ratio 3073 is an allocation ratio which indicates the allocation ratio of storage capacity allotted to the respective tiers identified with the tier numbers 3072 by parts per ten. The page ID 3074 records identification codes for identifying the pages as P01, P02 and so on, for example, each of which being a unit physical storage area allotted to any of the respective tiers in the LU 356. It is to be noted that the tier arrangement policy 3071 is information which is referred to when a data copy process or a migration process is carried out between the LUs defining a pair. The tier arrangement in the policy table 307 may be different from that in the LU 356 which shows dynamic change during operation of the actual storage system 1 as illustrated in FIG. 7. The tier arrangement in the policy table 307 may be updated in synchronization with an actual tier arrangement in the LU 356 in operation.

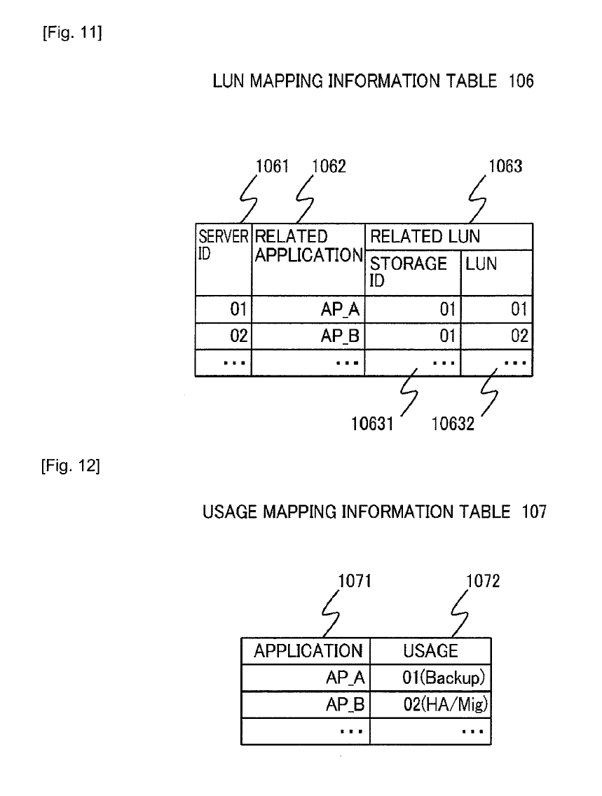

Next, the LUN mapping information table 106 will be described. FIG. 11 is an example of the LUN mapping information table 106. The LUN mapping information table 106 records the respective items of a server ID 1061, a related application 1062, and a related LUN 1063 in a mutually correlated manner. The server ID 1061 records an identification code assigned to the service server 200. The related application 1062 records an identification code for identifying a service application 203 operating in the service server 200 identified by the server ID 1061. The related LUN 1063 records a storage ID 10631 and an LUN 1063 as subitems, regarding the LU356 used by the corresponding related application 1062.

Next, the usage mapping information table 107 will be described. FIG. 12 shows an example of the usage mapping information table 107. The usage mapping information table 107 records the items of an application 1071 and a usage 1072 in a mutually correlated manner. The application 1071 is an identification code for identifying the service application 203 operating in the service server 200, and corresponds to the related application 1062 in the LUN mapping information table 106. The usage 1072 records an identification code indicating a usage of the pair of the LUs 356 for the corresponding application 1071. The usage 1072 corresponds to the option 1054 in the pair configuration information table 105. It is to be noted that the option 1054 in the pair configuration information table 105 may be set through a manual operation of a system administrator or through a process procedure precedently defined in the data migration management part 103 of the management server 100. The usage mapping information table 107 may be set through any of the following manners such as distribution by the vendor of the data migration management part 103 of the management server 100, a manual operation by a system administrator through the management server 100, and retrieval from the pair configuration information table 105.

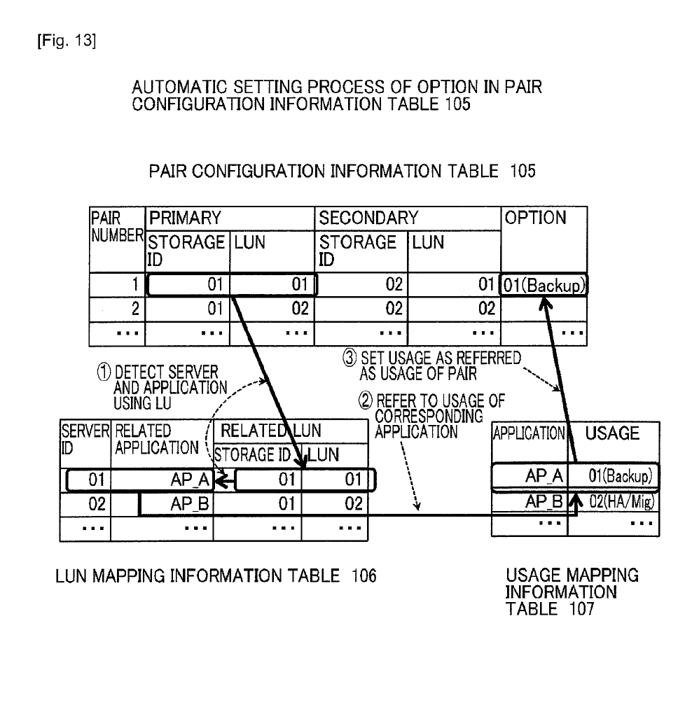

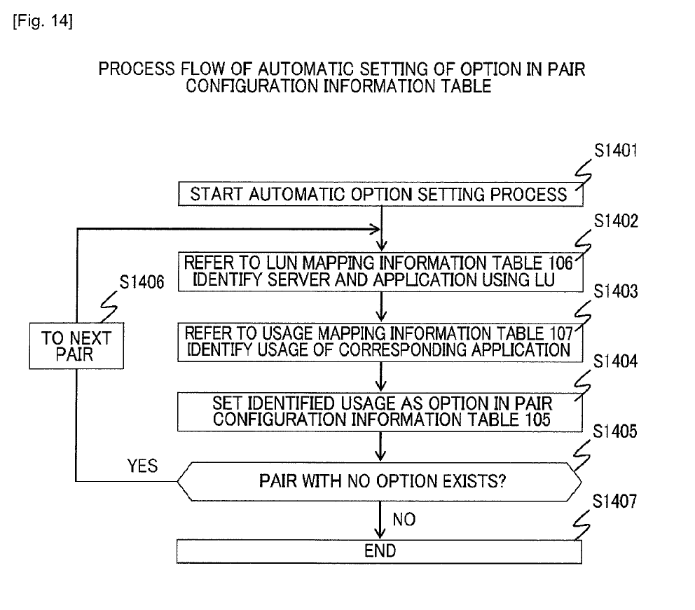

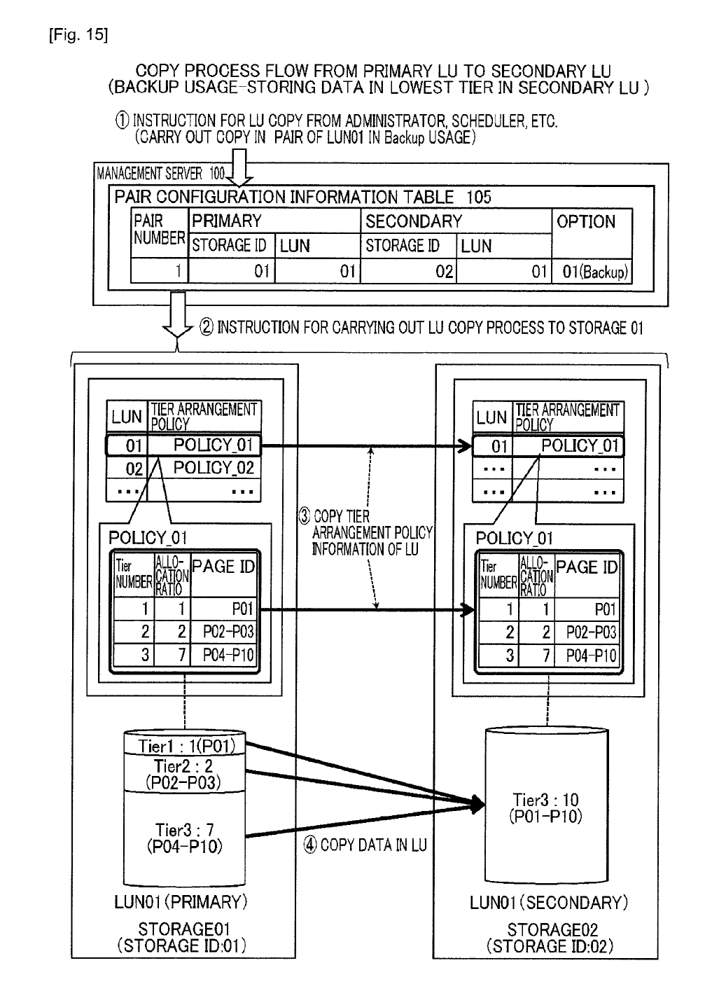

Here, the process of setting the option 1054 in the pair configuration information table 105 carried out by the data migration management part 103 of the management server 100 is described. FIG. 13 shows an outline of this automatic option setting process, and FIG. 14 shows an example of an automatic setting process flow by the data migration management part 103. In FIG. 13, the encircled numbers indicate the sequence of the steps carried out, similarly in the rest of this specification.

As shown in FIG. 14, firstly, the data migration management part 103 starts the automatic option setting process (S1401), and identifies the service server 200 and the application 203 which is using any of the LUs 356 in the storage apparatus 300 with referring to the LUN mapping information table 106 (S1402). Then, the data migration management part 103 refers to the usage mapping information table 107, identifies the usage 1072 correlated to the application 203 identified at S1402 (S1403), and sets the identified usage 1072 as the option 1054 in the pair configuration information table 105 (S1404). The data migration management part 103 determines whether or not there is a pair of the LUs 356 to which the option 1054 is not set in the pair configuration information table 105 (S1405). If the data migration management part 103 determines there is (S1405, Yes), the data migration management part 103 selects any of the pairs to which the option 1054 is not set and returns the process to S1402. If the data migration management part 103 determines there is no pair to which the option 1054 is not set at S1405 (S1405, No), the data migration management part 103 terminates the process (S1407).

According to the above automatic option setting process, the tier arrangement option suitable to a pair of the LUs 356 used by an application can be automatically set according to the usage of the application.

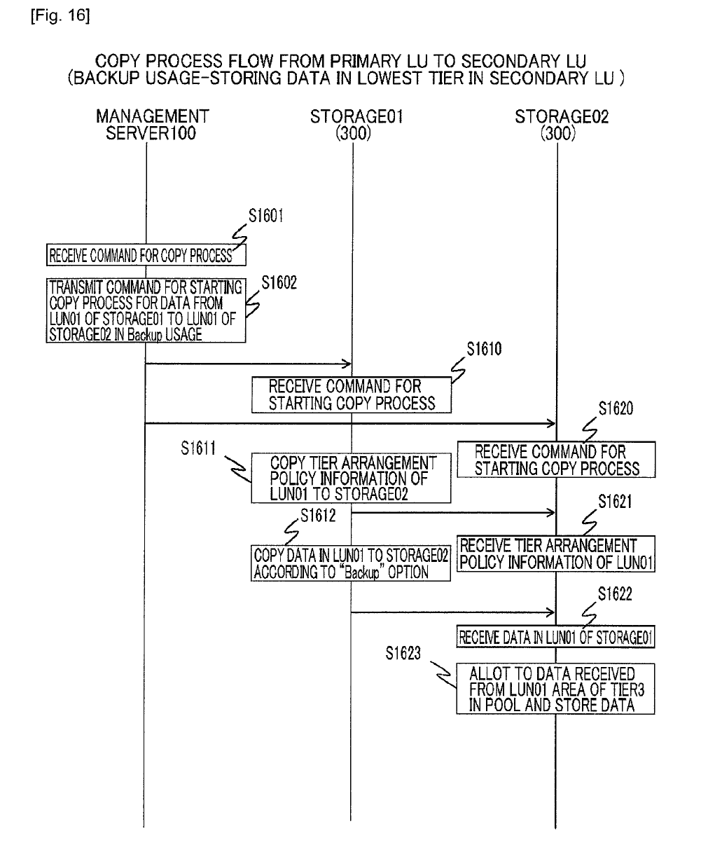

Next, a data copy process carried out for data backup from the primary LU to the secondary LU in the LUs configured as a pair will be described. FIG. 15 shows an outline of this data copy process. FIG. 16 shows an example of the data copy process flow. In the example in FIG. 15, the LUN01 of the storage ID01 and the LUN01 of the storage ID02 are configured as a pair, and the data stored in the LUN01 of the storage ID01 are copied to the LUN01 of the storage ID02 according to a predetermined tier arrangement policy. According to the tier arrangement policy in FIG. 15, all the data copied to the LUN01 of the storage ID02 are allotted to Tier3. As employed above, the storage apparatus 300 to which “01” is assigned as the storage ID 10521 will be mentioned as storage 01, and the LU 356 to which “01” is assigned as the LUN 1053 of the identification number of the LU 356 will be mentioned as LUN01 hereinbelow.

Referring to the exemplary process flow in FIG. 16, first, the management server 100 receives a command for a data copy process with the data migration management part 103 (S1601), and the data migration management part 103 transmits to the storage apparatuses 300 as the storage 01 and the storage 02 a command for starting the process of copying the data stored in the LUN01 of the storage 01 to the LUN01 of the storage 02 (S1602).

The data migration control parts 305 of the storage 01 and the storage 02 that received the command for carrying out the data copy process from the management server 100 also receive the option 1054 recorded in the pair configuration information table 105 in the management server 100 respectively (S1610, S1620). In the example in FIGS. 15 and 16, the option 1054 is “01(Backup).”

The data migration control part 305 of the storage 01 retrieves the tier arrangement policy information for the LUN01 from the tier arrangement policy information table 306 and transmits the same to the storage 02 (S1611). The storage 01 copies the data stored in the LUN01 to the storage 02 according to the instruction indicated in the option 1054 received from the management server 100 (S1612).

The data migration control part 305 of the storage 02 receives from the data migration control part 305 of the storage 01 the tier arrangement policy information on the LUN01 (S1621), and receives the data stored in the LUN01 of the storage 01 (S1622). The data migration control part 305 of the storage 02 allots to the data received from the storage 01 the page(s) belonging to Tier 3 of the pool 354 and stores the same in the LUN01, and terminates the process (S1623). In the present embodiment, when 01(Backup) is set to the option 1054, the target area of the data to be copied according to the corresponding option 1054 is the page belonging to the Tier3 as the lowest tier in the LUN01. The correspondence between the option 1054 and the target tier of data storage may be stored in the program memory 330, for example.

According to the data copy process above, when a data backup process is carried out between the LUs 356 configured as a pair, the data copy can be realized according to the tier arrangement determined by the option set for the pair beforehand.

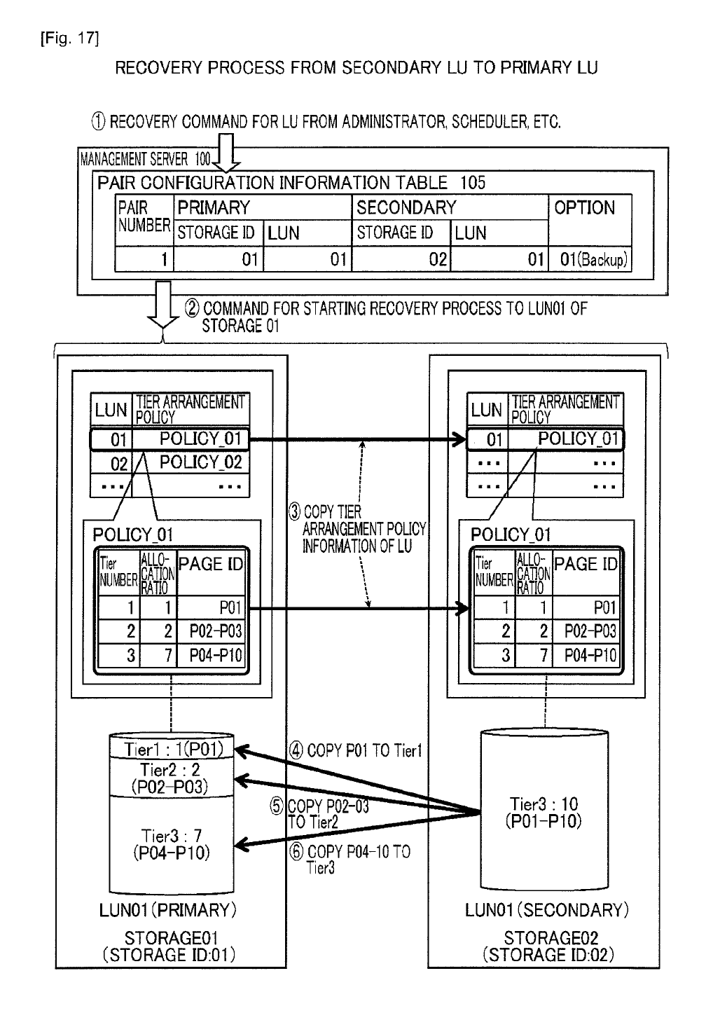

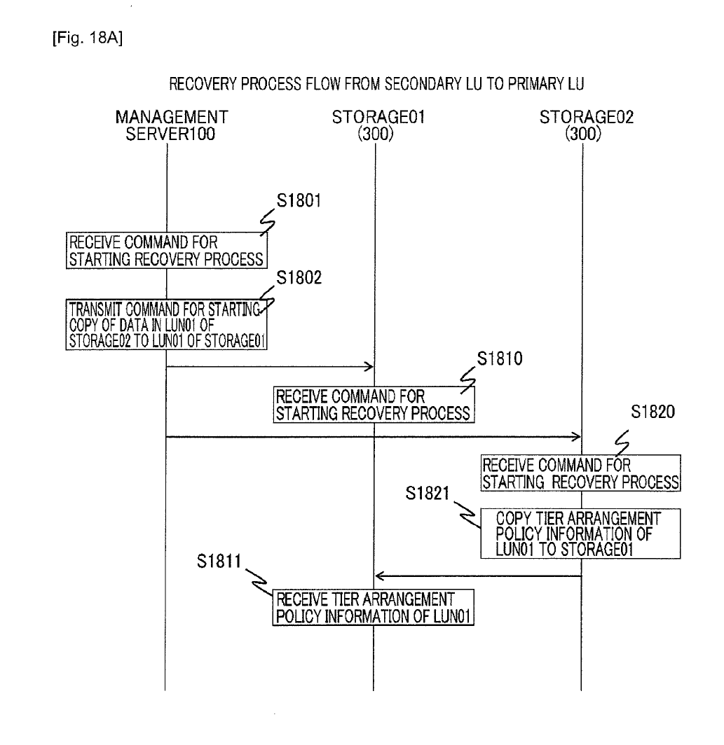

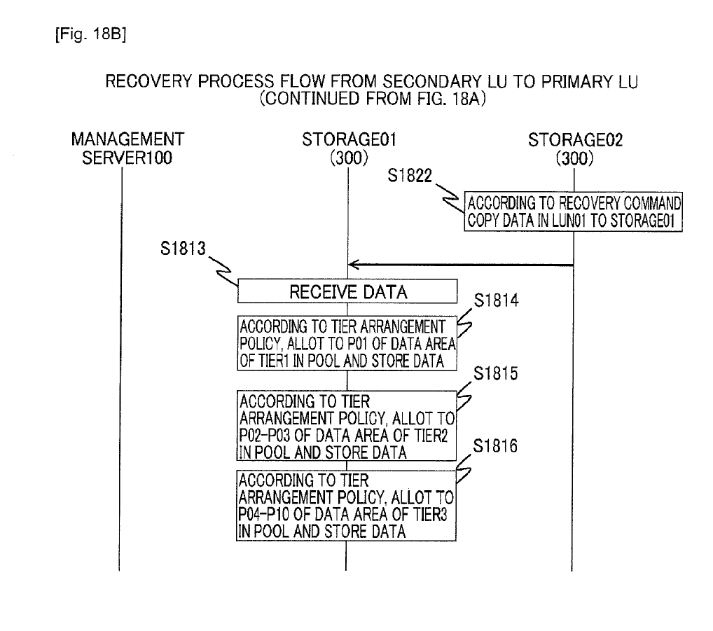

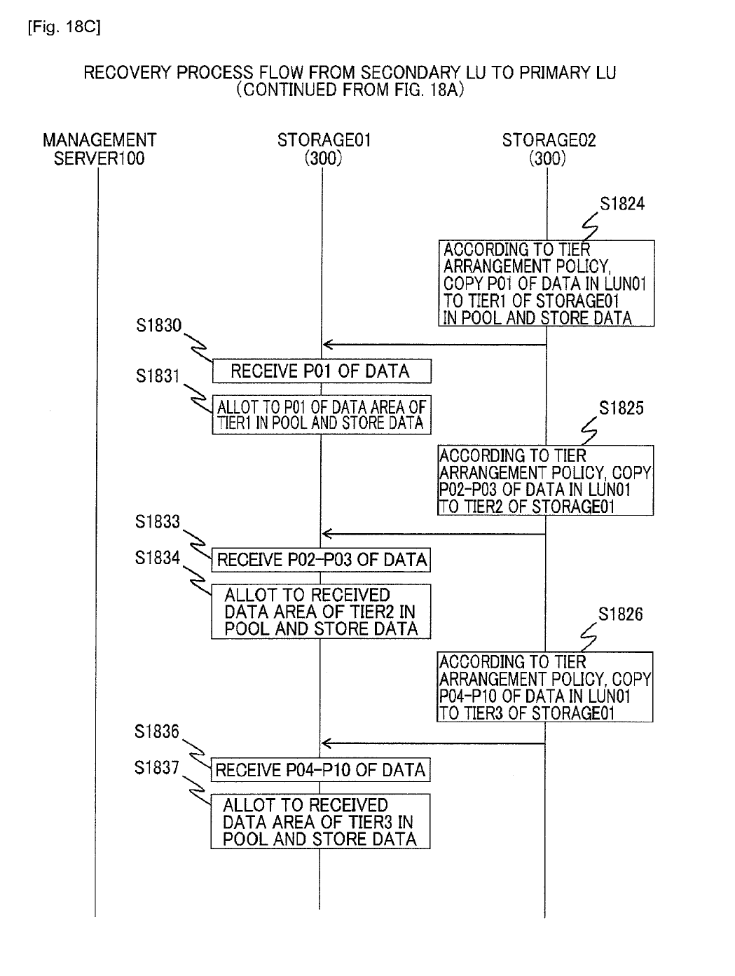

Next, a data copy process carried out for recovering data from the secondary LU to the primary LU in the LUs 356 configured as a pair will be described. FIG. 17 shows an outline of the recovery process. FIG. 18A-FIG. 18C show an example of the recovery process flow. The recovery process for returning the data to the source of backup is carried out in the case where a failure once has occurred to the LU 356 as the primary LU in the backup source and another LU is available for replacement of the LU 356 with failure, for example. In the example in FIG. 17, similarly to the example in FIG. 15, the recovery process is carried out such that the LUN01 of the storage ID01 and the LUN01 of the storage ID02 are configured as a pair, and the data stored in the LUN01 of the storage ID02 are copied to the LUN01 of the storage 01 according to the predetermined tier arrangement policy. According to the tier arrangement policy in FIG. 17, the data allotted to the Tier3 in the LUN01 of the storage 02 are copied to the LUN01 of the storage 01 according to the tier arrangement in the storage 01 through the recovery process.

Referring to the exemplary process flows in FIG. 18A-FIG. 18B, first, the management server 100 receives a command for carrying out the recovery process at the data migration management part 103 (S1801). Then, the data migration management part 103 transmits to the storage apparatuses 300 as the storage 01 and the storage 02 a command for starting a process of copying the data stored in the LUN01 of the storage 02 to the LUN01 of the storage 01 (S1802).

The respective data migration control parts 305 of the storage 01 and the storage 02 receive from the management server 100 a command for carrying out the data copy process (S1810, S1820). The data migration control part 305 of the storage 02 refers to the tier arrangement policy information table 306 and transmits the tier arrangement policy information for the LUN01 to the storage 01 (S1821). The data migration control part 305 of the storage 01 receives the tier arrangement policy information for the LUN01 from the storage 02 (S1811).

The data migration control part 305 of the storage 02 transmits the data stored in the LUN01 to the storage 01 (S1822). The data migration control part 305 of the storage 01 receives the data from the storage 02 (S1813), and carries out the tier arrangement according to the tier arrangement policy information for the LUN01 already received from the storage 02. More particularly, the data migration control part 305 of the storage 01 stores the data in the LUN01 by allotting the areas of the Tier1, Tier2, and Tier3 of the pool 354 respectively, to the Page01, hereinafter abbreviated “P01” and the like, P02 and P03, and P04-P10 in the received data, and terminates the process (S1814-S1816).

FIG. 18C shows an example of a different process flow which may be carried out subsequent to the process flow in FIG. 18A.

The data migration control part 305 of the storage 02 transmits the data of P01 among the data stored in the LUN01 to the storage 01 (S1824). The data migration control part 305 of the storage 01 receives the data of P01 from the storage 02 (S1830), and stores the data in the LUN01 by allotting the Tier1 of the pool 354 to the data according to the tier arrangement policy information for the LUN01 already received from the storage 02 (S1813). Then, similarly, the data migration control part 305 of the storage 02 transmits the data of P02 and P03 among the data stored in the LUN01 to the storage 01 (S1825). The data migration control part 305 of the storage 01 receives the data of P02 and P03 from the storage 02 (S1833), and stores the data in the LUN01 by allotting the Tier2 of the pool 354 to the data according to the tier arrangement policy information for the LUN01 already received from the storage 02 (S1834). Lastly, the data migration control part 305 of the storage 02 transmits the data of P04-P10 among the data stored in the LUN01 to the storage 01 (S1826). The data migration control part 305 of the storage 01 receives the data of P04-P10 from the storage 02 (S1836), and stores the data in the LUN01 by allotting the Tier3 of the pool 354 to the data according to the tier arrangement policy information for the LUN01 already received from the storage 02, and terminates the process (S1837). The process flow in FIG. 18C is different from that in FIG. 18B in that the data copy from the storage 02 to the storage 01 is carried out tier by tier.

According to the above process, when writing back to the LUN 356 of the backup source the backup data, the data can be stored in the LUN 356 as a backup source according to the tier arrangement policy defined therefor.

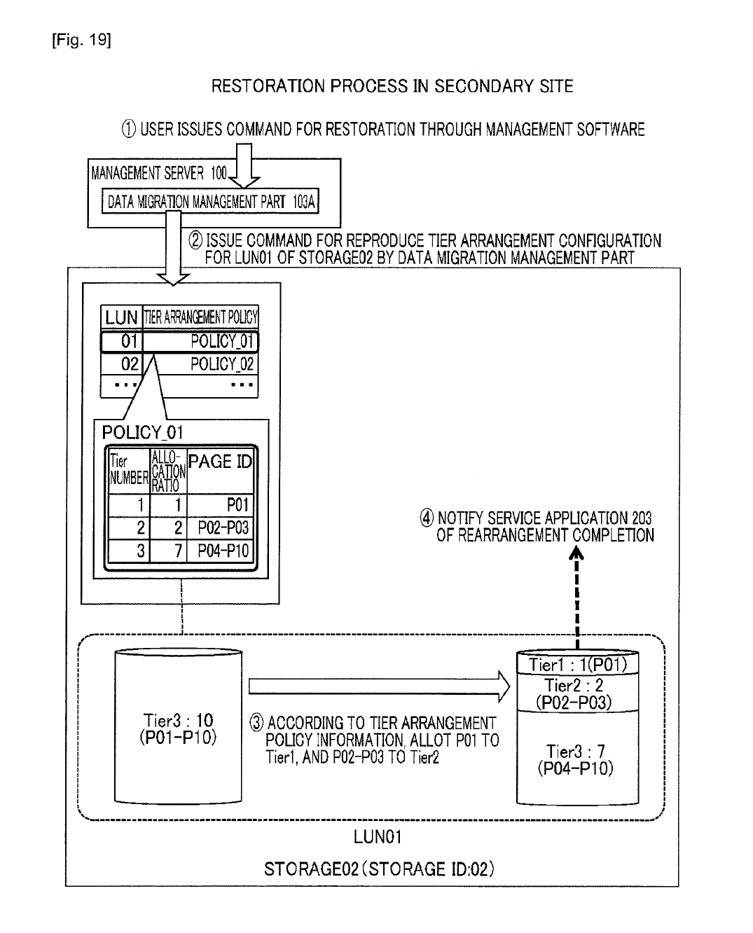

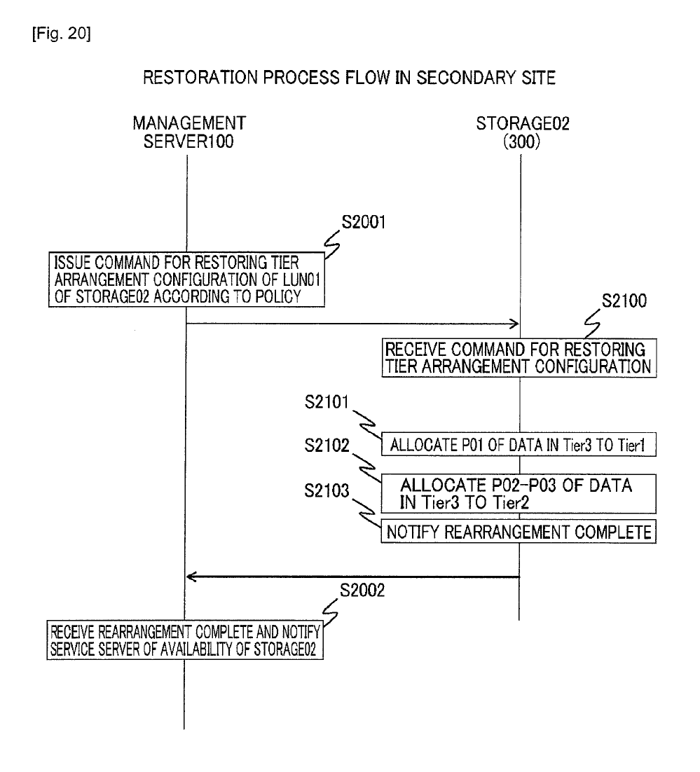

Next, a data restoration process for using the secondary LU as the active primary LU using the backup data in the secondary LU of the LUs 356 configured as a pair is described. The data restoration process at the storage apparatus 300 as a target of data backup will be carried out when a failure has occurred to the storage apparatus 300 as a backup source itself, which prevents normal operation. FIG. 19 shows an outline of the data restoration process. FIG. 20 shows an example of the data restoration process flow. In the example in FIG. 19, a rearrangement of the tiers is carried out for the data, P01-P10 according to the tier arrangement policy applied in the storage 01 as a backup source, the data allotted to the lowest tier, the Tier3 according to the tier arrangement policy applied when the data backup was made.

Referring to the exemplary process flow in FIG. 20, first, the management server 100 transmits to the data migration control part 305 of the storage 02 by the data migration management part 103 a command for carrying out rearrangement of the tier arrangement of the LUN01 of the storage 02 according to the tier arrangement policy information recorded in the tier arrangement policy information table 306 (S2001).

The data migration control part 305 of the storage 02 receives a command for carrying out the tier rearrangement from the management server 100 (S2100), and allots the data of P01 and the data of P02, P03 from the Tier3 to the Tier1, and from the Tier3 to the Tier2, respectively. (S2101, S2102).

Next, the data migration control part 305 of the storage 02 notifies to the management server 100 that the tier arrangement policy for the LUN01 of the storage 02 has been restored (S2103). The data migration management part 103 of the management server 100 receives the notification of completion of the rearrangement from the storage 02, and notifies to the service server 200 using the LUN01 that the LUN01 has become available in the storage 02, and terminates the process (S2002).

According to the above data restoration process, the data in the storage apparatus 300 as a data backup target can be utilized according to the tier arrangement policy applied at the backup source.

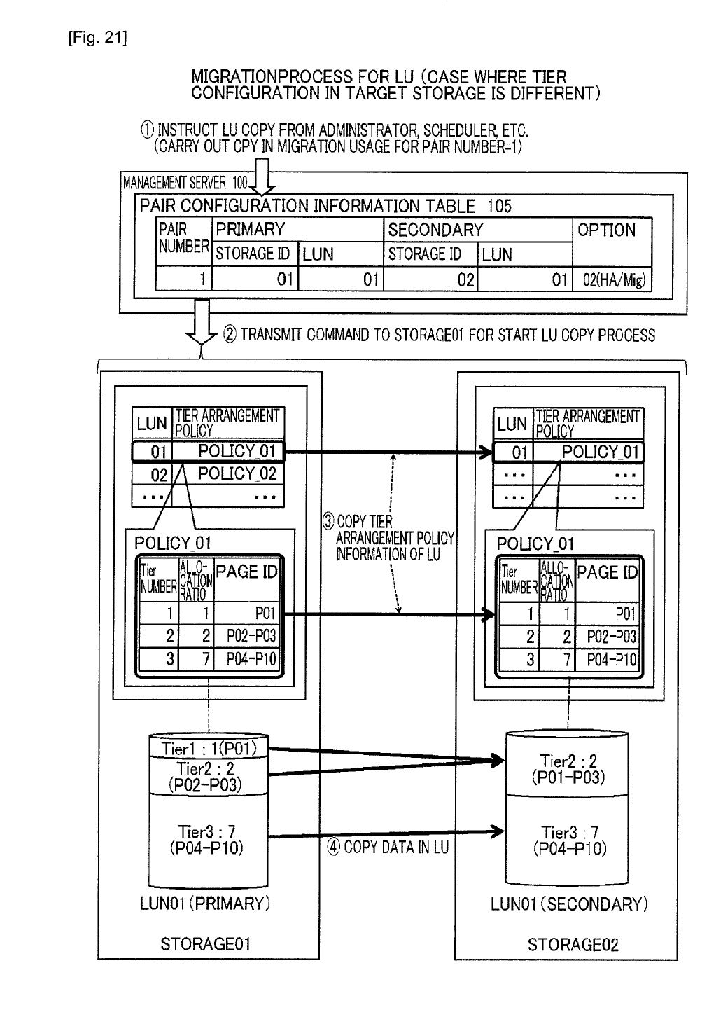

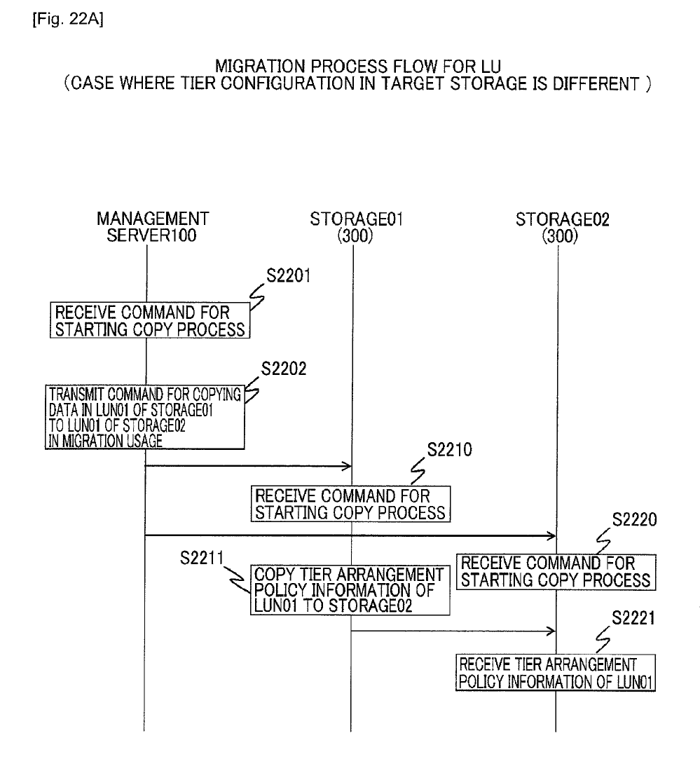

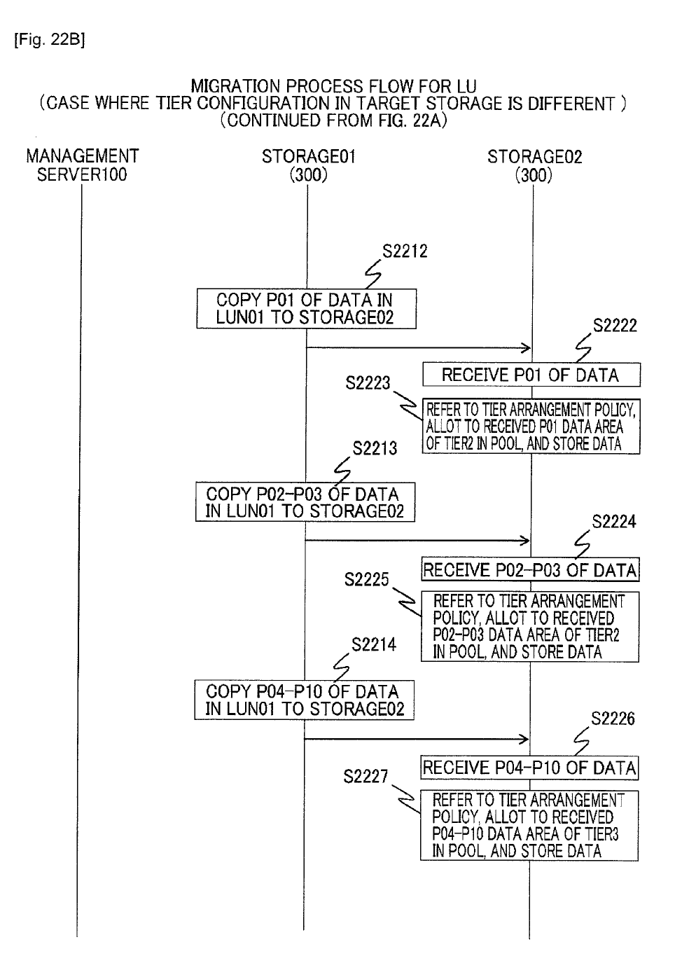

Next, the data copy process will be described, the process being carried out for a purpose of migration from the primary LU to the secondary LU of the LUs 356 configured as a pair. The process will be hereinafter simply referred to a “migration process.” In the migration process, the tiers are allotted to the data to be copied according to the tier arrangement policy applied to in the copy target. FIG. 21 shows an outline of the migration process. FIGS. 22A and 22B show an example of the migration process flow.

In the example of FIG. 21, the LUN01 of the storage 01 and the LUN01 of the storage 02 are configured as a pair, and “02(HA/Mig)” is recorded in the corresponding option 1504 in the pair configuration information table 105. For the pair configured with the LUN01 of the storage 01 and the LUN01 of the storage 02, the copy process is carried out in which the data stored in the LUN 01 of the storage 01 are copied to the LUN01 of the storage 02 according to the predetermined tier arrangement policy in the storage 02 for improving availability of the storage system 1, or for higher availability (HA) of the storage system 1. According to the tier arrangement policy in FIG. 21, the data allotted to the Tier1-Tier3 in the LUN01 of the storage 01 are allotted to the Tier2 and the Tier3 in the LUN01 of the storage 02. The data allotted to the Tier1 as the highest tier in the storage 01 are allotted to the Tier2 as the highest tier in the storage 02.

Referring to the exemplary process flow in FIGS. 22A and 22B, first, the management server 100 receives a command for carrying out a migration process by the data migration management part 103 (S2201). The data migration management part 103 transmits to the storage apparatuses 300 as the storage 01 and the storage 02 a command for starting the migration process of migrating the data stored in the LUN01 of the storage 01 to the LUN01 of the storage 02 (S2202). The migration process may be triggered by any of a command input by a system administrator into the management server 100, a command issued from a scheduler provided in the data migration management part 103 of the management server 100, and so on.

The data migration control parts 305 of the storage 01 and the storage 02 receive the command for carrying out the data copy process from the management server 100, respectively (S2210, S2220). The data migration control part 305 of the storage 01 refers to the tier arrangement policy information table 306 and transmits the tier arrangement policy information for the LUN01 to the storage 02 (S2211). The data migration control part 305 of the storage 02 receives the tier arrangement policy information for the LUN01 from the storage 01 (S2221).

The data migration control part 305 of the storage 01 transmits the data of P02 among the data stored in the LUN01 to the storage 02 (S2212). The data migration control part 305 of the storage 02 receives the data of P01 from the storage 01 (S2222), allots the Tier2 of the pool 354 to the data according to the tier arrangement policy information for the LUN01 already received from the storage 01, and stores the data into the LUN01 (S2223).

Next, similarly, the data migration control part 305 of the storage 01 transmits the data of P02 and P03 among the data stored in the LUN01 to the storage 02 (S2213). The data migration control part 305 of the storage 02 receives the data of P02 and P03 from the storage 01 (S2224), allots the Tier2 of the pool 354 to the data according to the tier arrangement policy information for the LUN01 already received from the storage 01, and stores the data into the LUN01 (S2225). Lastly, the data migration control part 305 of the storage 01 transmits the data of P04-P10 among the data stored in the LUN01 to the storage 02 (S2214). The data migration control part 305 of the storage 02 receives the data of P04-P10 from the storage 01 (S2226), allots the Tier3 of the pool 354 to the data according to the tier arrangement policy information for the LUN01 already received from the storage 01, stores the data into the LUN01, and terminates the process (S2227).

According to the above process, when the tier arrangement policies are different between at the data copy source and at the data copy target in the Lus 356 configuring a pair, the data copy process can be carried out according to the tier arrangement policy at the data copy target.

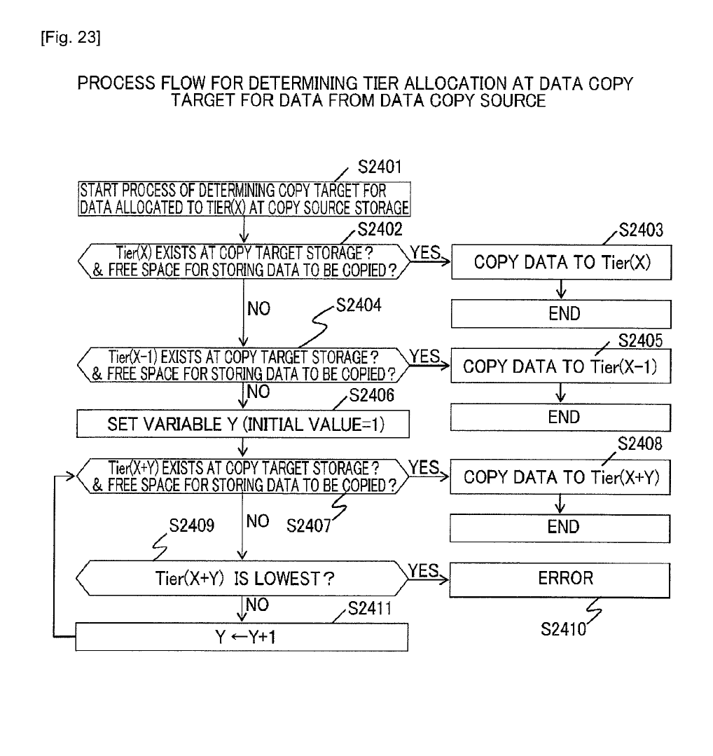

FIG. 23 shows an example of a tier arrangement determination flow for the LU 356 at the data copy target in the inter-LU data copy process for migration as described above referring to FIGS. 21-22B. The process indicates a procedure of determining the tier arrangement at the data copy target when the tier arrangement policies are different between in the LU 356 as the data copy source and in the LU 356 as the data copy target.

At S2221 in FIG. 22A, when the data migration control part 305 of the storage 02 has received the tier arrangement policy for the LUN01 of the storage 01 from the data migration control part 305 of the storage 01, the data migration control part 305 of the storage 02 starts the tier arrangement determination process for the data allotted to a certain tier, TierX, in the data copy target in the LUN01 of the storage 02 (S2401). It is assumed X is an integer equal to or larger than 1.

The data migration control part 305 of the storage 01 determines whether or not both TierX and a required space exist in the LUN01 of the storage 02 (S2402). If determined that both exist (S2402, Yes), the data migration control part 305 of the storage 01 allots the data allotted to the TierX to the TierX in the LUN01 of the storage 02, and terminates the process (S2403).

If determined at S2402 that either of the TierX and the required space does not exist (S2402, No), the data migration control part 305 of the storage 01 determines whether or not both the Tier(X−1) and a required space exist in the LUN01 of the storage 02 (S2404). If determined that both exist (S2404, Yes), the data migration control part 305 of the storage 02 allots the data allotted to the TierX to the Tier(X−1) of the LUN01 of the storage 02, stores the data in the LUN01, and terminates the process (S2405).

If determined at S2404 that either of the Tier(X−1) and the required space does not exist (S2404, No), the data migration control part 305 of the storage 02 sets a variable Y which has an initial value of 1, for example, in a temporary memory area in the program memory 330 (S2406). Then, the data migration control part 305 of the storage 02 determines whether or not both the Tier(X+Y) and a required space exist in the LUN01 of the storage 02 (S2407). If determined that both exist (S2407, Yes), the data migration control part 305 of the storage 02 allots the data allotted to the Tier(X−1) to the Tier(X+Y) of the LUN01 of the storage 02, stores the data in the LUN01, and terminates the process (S2408).

If at S2407 determined either of the Tier(X+Y) and the required space does not exist (S2407, No), the data migration control part 305 of the storage 02 determines whether or not the Tier(X+Y) is the lowest tier in the LUN01 (S2409). If determined the Tier(X+Y) is the lowest tier in the LUN01 (S2409, Yes), the data migration control part 305 of the storage 02 determines the data copy target to which the data are to be copied from the storage 01 does not exist, sends an error message to the management server 100, and terminates the process (S2410).

If determined at S2409 that the Tier(X+Y) is not the lowest tier in the LUN01

(S2409, No), the data migration control part 305 of the storage 02 adds 1 to the variable Y and returns the process to S2407 (S2411).

According to the process flow described above, the data migration control part 305 of the storage 02 as the data copy target according to the process of S2401-S2402, if the tier exists in the data copy target such that the tier is equivalent to or lower than the tier in the data copy source and is able to store the data, copies the data to the tier as high as possible sequentially. On the other hand, the data migration control part 305 of the storage 02 as the data copy target according to the process of S2406-S2411, if, in the data copy target, the tier equivalent to or lower than the tier in the data copy source does not exist but the higher tier which is able to store the data exists, copies the data sequentially to the tier as low as possible sequentially. Accordingly, in the LU 356 as the data copy target, the data copy for migration can be carried out while load on the higher tier of higher access frequency is maintained as small as possible.

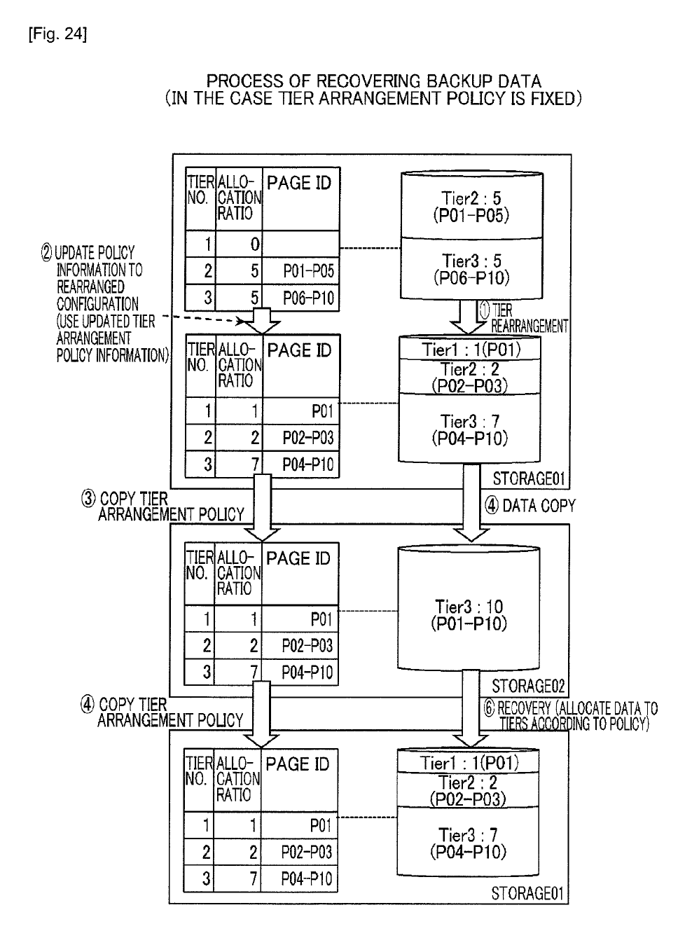

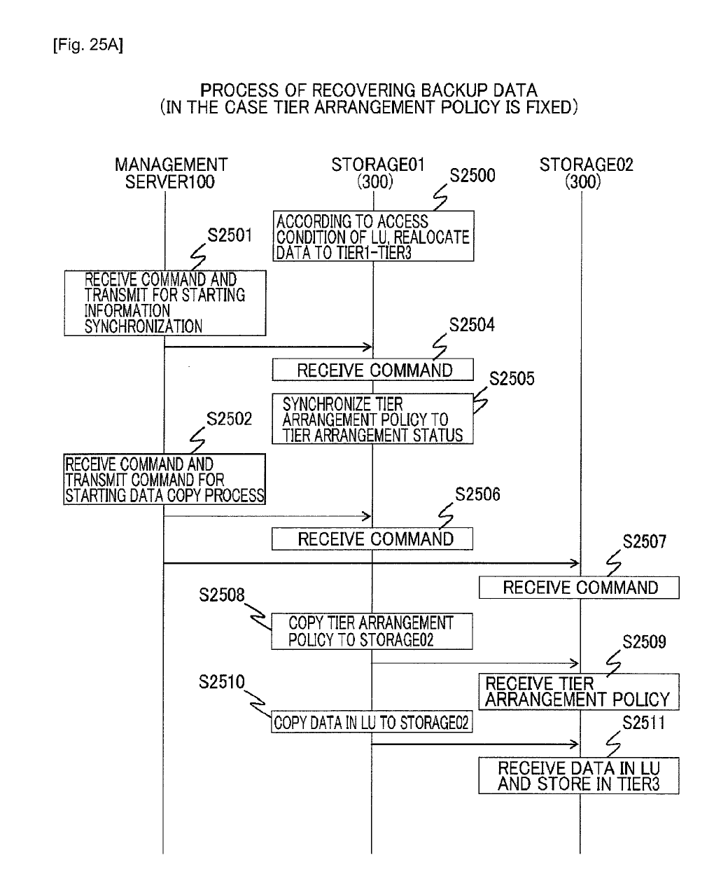

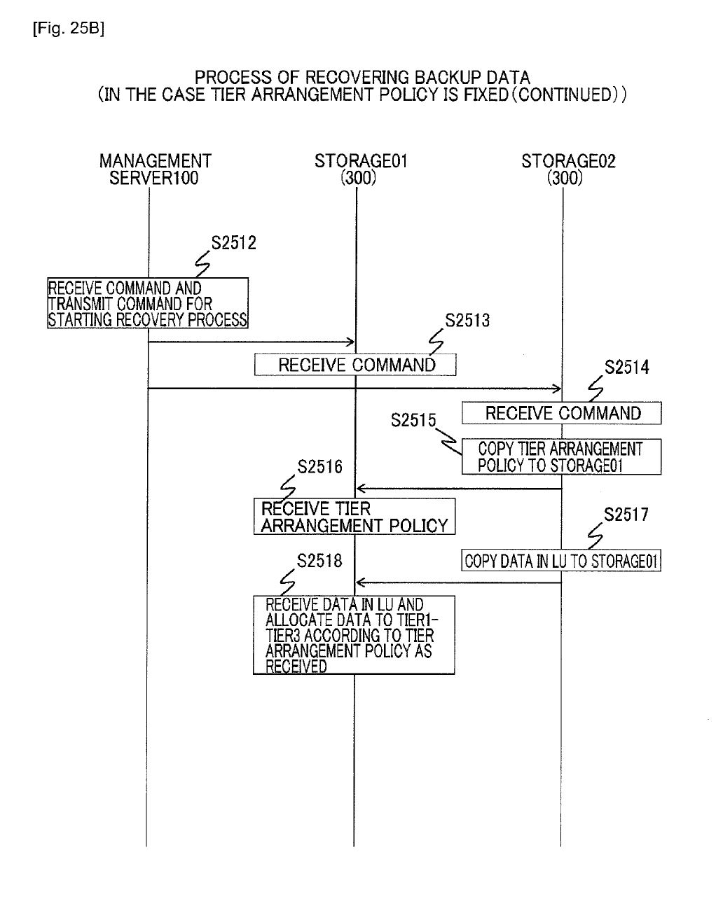

Next, the process will be described in which, between the LUs 356 configured as a pair, data backup is made to the secondary LU 356 while maintaining the tier arrangement policy at the primary LU 356, and then, the recovery process for the data to the primary LU 356 is made. FIG. 24 shows an outline of the backup/recovery process. FIGS. 25A and 25B show an example of the backup/recovery process flow.

As shown in FIG. 24, in the backup/recovery process, the data stored in the LU 356 of the storage 01 are copied to the LU 356 as the data copy target which configure a pair with the data copy target according to the tier arrangement when the backup option is applied. Then, the data are subject to the recovery process in which the data are copied to the LU 356 of the storage 01 according to the tier arrangement prior to the backup process.

Referring to the backup/recovery process flow in FIGS. 25A and 25B, first, the data migration control part 305 of the storage 01 timely adjusts the tier arrangement in the LU 356 based on the access frequency of an external apparatus such as the service server 200 for the LU 356 (S2500). The adjustment of the tier arrangement may be realized such that the access frequency and the tier arrangement are preliminarily managed in the data migration control part 305 in a mutually correlated manner and the data may be reallocated to each of the tiers at a fixed time interval. In the example in FIG. 25, the tier arrangement is adjusted in the storage 01 once, and after then, the tier arrangement policy is controlled to hold the adjusted tier arrangement.

The management server 100 receives a command for carrying out the data copy process by the data migration management part 103, and the data migration management part 103 transmits a command for synchronizing the tier arrangement policy information to the data migration control part 305 of the storage 01 (S2501).

The data migration control part 305 of the storage 01 which has received the command for carrying out synchronizing the tier arrangement policy information from the management server 100 changes the recorded content of the tier arrangement policy information table 306 according to the tier arrangement status of the LU 356 at the instance of receiving the command for carrying out the synchronization (S2505). In the example in FIG. 25, such a change has been made that the data allotted to the Tier2 and the Tier3 in the LU 356 are allotted to the Tier1-Tier3.

The data migration management part 103 of the management server 100 transmits to the storage apparatuses 300 as the storage 01 and the storage 02 a command for starting copying the data stored in the LUN01 of the storage 01 to the LUN01 of the storage 02, respectively (S2502).

The data migration control parts 305 of the storage 01 and the storage 02 respectively receive the command for carrying out the data copy process from the management server 100 (S2506, S2507). The data migration control part 305 of the storage 01 refers to the tier arrangement policy information table 306 and transmits the tier arrangement policy information of the LUN01 to the storage 02 (S2508). The data migration control part 305 of the storage 02 receives the tier arrangement policy information of the LUN01 from the storage 01 (S2509).

The data migration control part 305 of the storage 01 copies the data stored in the LUN01 to the storage 02 according to the option 1054 recorded in the pair configuration information table 105, the option 1054 being recorded for the LUN01 received from the management server 100 (S2510).

The data migration control part 305 of the storage 02 receives the data stored in the LUN01 of the storage 01 from the data migration control part 305 of the storage 01, allots the data to the Tier3, and stores the data in the LUN01 (S2511).

Next, referring to FIG. 25B, in the recovery process flow, the management server 100 first receives the command for carrying out the recovery process by the data migration management part 103, the data migration management part 103 transmits to the storage apparatuses 300 as the storage 01 and the storage 02 a command for starting copying the data stored in the LUN01 of the storage 02 to the LUN01 of the storage 01, respectively (S2512).

The data migration control parts 305 of the storage 01 and the storage 02 respectively receive the command for carrying out the data copy process from the management server 100 (S2513, S2514). The data migration control part 305 of the storage 02 refers to the tier arrangement policy information table 306 and transmits the tier arrangement policy information of the LUN01 to the storage 01 (S2515). The data migration control part 305 of the storage 01 receives the tier arrangement policy information of the LUN01 from the storage 02 (S2516).

The data migration control part 305 of the storage 02 transmits the data stored in the LUN01 to the storage 01 (S2517). The data migration control part 305 of the storage 01 receives the data from the storage 02, and carries out the tier arrangement according to the tier arrangement policy information for the LUN01 already received from the storage 02. In other words, the data migration control part 305 of the storage 01 stores the data by respectively allotting the areas of the Tier1, Tier2, and Tier3 of the pool 354 to the data of P01, P02 and P03, and P04-P10 in the received data, and terminates the process (S2518).

According to the process described above, the data copied according to the tier arrangement policy at the data copy target when the data backup is made to the LU 356 as the data copy target are copied to the LU 356 as the data copy source according to the tier arrangement policy applied at the data copy source upon the recovery process. Therefore, there is no need to carry out the tier rearrangement at the data copy source after the recovery.

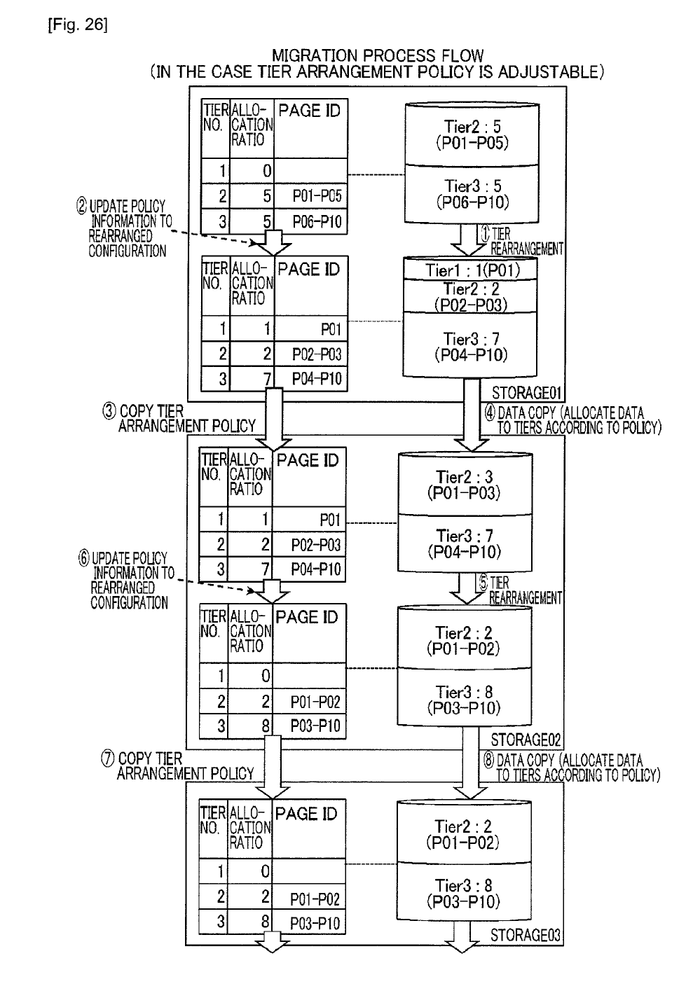

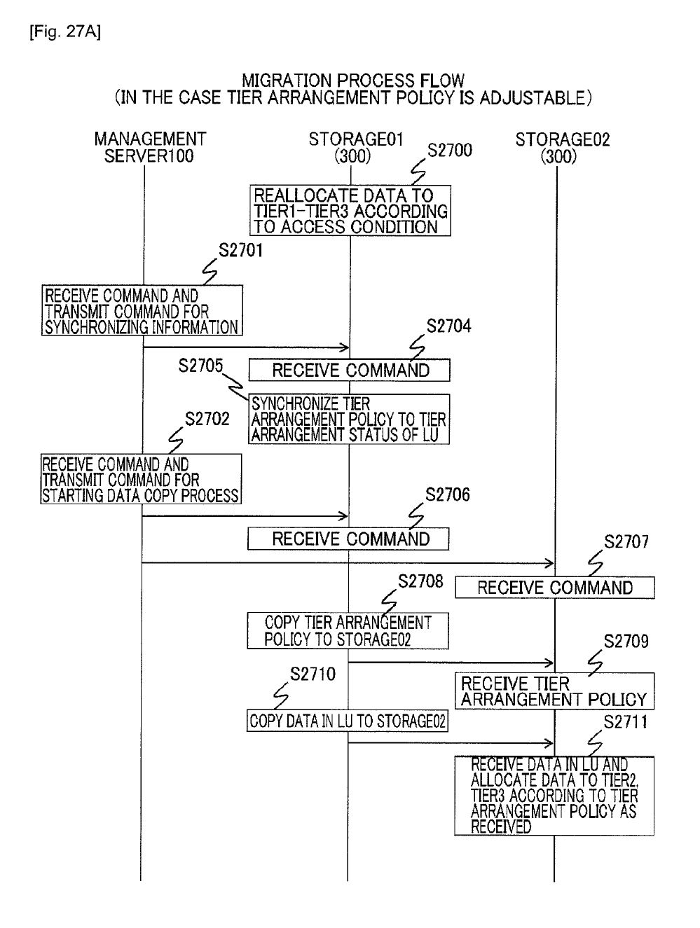

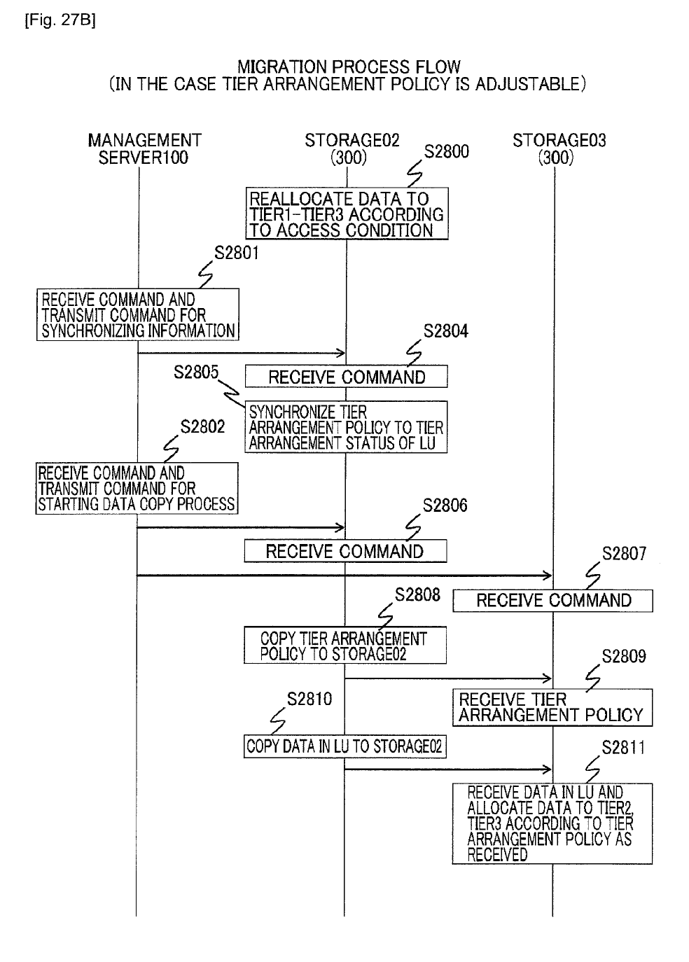

Next, the process of data copy will be described, in which the data stored in the LU 356 of the storage apparatus 300 are copied while the tier arrangement on the data are changed according to the tier arrangement policy set on the LU 356 as the data copy target. FIG. 26 shows an outline of the data copy process to be carried out while the tier arrangement policy is changed according to the latest policy at the data copy target. FIGS. 27A and 27B show an example of the data copy process flow.

As shown in FIG. 26, in this data copy process according to the latest tier arrangement policy at the data copy target, when the tier rearrangement is carried out at the data copy target, the data copy process directed to the subsequent data copy target while the tier arrangement after the tier rearrangement is maintained. In the example in FIG. 26, the data stored in the LU 356 of the storage 01 are copied to the storage 02, and then, from the storage 02 to the storage 03. It is to be noted that, though not shown in FIG. 1, the storage 03 is a storage apparatus 300 having the same construction as the storage 01 and the storage 02. Here, the tier rearrangement is carried out at the storage 02 and the storage 03 according to the access frequency regarding the data to be copied. If the data copy to a different storage apparatus 300 is carried out after the tier rearrangement, the data are subject to a reallocation of the tiers according to the tier rearrangement. The migration process shown in FIG. 26 as an example is applied when the migration is carried out from a local site to a plurality of remote sites sequentially.

Referring to the data copy process flow in FIG. 27A, first, the data migration control part 305 of the storage 01 timely adjusts the tier arrangement of the LU 356 according to the access frequency of the external apparatus such as the service server 200 regarding the LU 356 (S2700). The adjustment of the tier arrangement is the same process as the process at S2500 in FIG. 25A.

The management server 100 receives a command for carrying out the data copy process by the data migration management part 103. Then, the data migration management part 103 transmits to the data migration control part 305 of the storage 01 a command for synchronizing the tier arrangement policy information (S2701).

The data migration control part 305 of the storage 01 that has received the command for synchronizing the tier arrangement policy information from the management server 100 changes the record content of the tier arrangement policy table 306 according to the tier arrangement status in the LU 356 at the instance of receiving the command for synchronization (S2704, S2705). In the example of FIG. 27, regarding the LU 356, such a change has been made that the data allocated to the Tier2 and the Tier3 are allocated to the Tier1-Tier3.

The data migration management part 103 of the management server 100 transmits to the storage apparatuses 300 as the storage 01 and the storage 02 a command for carrying out the process of copying the data stored in the LUN01 of the storage 01 to the LUN01 of the storage 02 (S2702).

The data migration control parts 305 of the storage 01 and the storage 02 respectively receive from the management server 103 the command for carrying out the data copy (S2706, S2707). The data migration control part 305 of the storage 01 refers to the tier arrangement policy information table 306 and transmits to the storage 02 the tier arrangement policy information of the LUN01 (S2708). The data migration control part 305 of the storage 02 receives from the storage 01 the tier arrangement policy information of the LUN01 (S2709).

The data migration control part 305 of the storage 01 copies to the storage 02 the data stored in the LUN01 according to an indication of the option 1054 for the LUN01 recorded in the pair configuration information table 105 as received from the management server 100 (S2710).

The data migration control part 305 of the storage 02 receives from the data migration control part 305 of the storage 01 the data stored in the LUN01 of the storage 01 and stores the data into the LUN01 while allocating to the Tier2 and Tier3 (S2711). This is because the LUN01 of the storage 02 has only the Tier2 and the Tier3. According to the above, the data copy process from the storage 01 to the storage 02 is completed.

Next, referring to the data copy process flow in FIG. 27B, first, the data migration control part 305 of the storage 02 timely adjusts the tier arrangement of the LU 356 according to the access frequency of the external apparatus such as the service server 200 (S2800). The adjustment of the tier arrangement is the same process as the process at S2500 in FIG. 25A. In the example of FIG. 26, the data migration control part 305 of the storage 02 changes allocation of the data to the Tier2 and Tier3.

The management server 100 receives a command for carrying out the data copy process by the data migration management part 103. Then, the data migration management part 103 transmits to the data migration control part 305 of the storage 02 a command for synchronizing the tier arrangement policy information (S2801).

The data migration control part 305 of the storage 02 that has received the command for synchronizing the tier arrangement policy information from the management server 100 changes the record content of the tier arrangement policy table 306 according to the tier arrangement status in the LU 356 at the instance of receiving the command for synchronization (S2804, S2805).

The data migration management part 103 of the management server 100 transmits to the storage apparatuses 300 as the storage 02 and the storage 03 a command for carrying out the process of copying the data stored in the LUN01 of the storage 02 to the LUN01 of the storage 03 (S2802).

The data migration control parts 305 of the storage 02 and the storage 03 respectively receive from the management server 103 the command for carrying out the data copy (S2806, S2807). The data migration control part 305 of the storage 02 refers to the tier arrangement policy information table 306 and transmits to the storage 02 the tier arrangement policy information of the LU 356 (S2808). The data migration control part 305 of the storage 03 receives from the storage 02 the tier arrangement policy information of the LU 356 (S2809).

The data migration control part 305 of the storage 02 copies to the storage 03 the data stored in the LU 356 according to an indication of the option 1054 for the LU 356 recorded in the pair configuration information table 105 as received from the management server 100 (S2810).

The data migration control part 305 of the storage 03 receives from the data migration control part 305 of the storage 02 the data stored in the LUN01 of the storage 02 and stores the data into the LUN01 while allocating to the Tier2 and Tier3 (S2811). According to the above, the data copy process from the storage 01 to the storage 02, and from the storage 02 to the storage 03 is completed.

According to the above process, when the data copy process between the storage apparatuses 300 as migration, the data allocation to the tiers can be changed according to the tier arrangement at the data copy target, and the data copy can carried out according to the latest tier arrangement policy at the data copy target.

According to the embodiment of the present invention described above, in a storage system and a control method of the storage system providing a data storage area which is virtualized in storage capacity and has hierarchized structure according to types of storage devices, data copying and/or data migration between different storage apparatuses while taking the hierarchical structure of the storage area into consideration is realized.

While the present invention is described according to one embodiment thereof with referring to the accompanying drawings, it is to be noted that the present invention should not be taken limitative to the embodiment. Any modification, variation of the present invention and the equivalents thereof that do not depart from the spirit of the present invention will be within the scope of the present invention.

1. A storage system comprising:
a first storage apparatus;
a second storage apparatus;
each of the first and second apparatuses including a logical storage area for storing data processed by an external apparatus, each of the first and second apparatuses including a pool of a plurality of unit physical storage areas constructing a physical storage area for providing the logical storage area for storing the data;
the unit physical storage areas being classified into a plurality of storage tiers according to storage area property information for characterizing each of the unit physical storage areas;
the logical storage area in the first storage apparatus and the logical storage area in the second storage apparatus respectively including one or more of the storage tiers that are assigned to the respective logical storage areas according to the unit physical storage areas correlated to the respective logical storage areas;
the storage system holding storage tier construction information that is information of construction of the storage tier in the logical storage area of the first storage apparatus; and
a data migration controller, when the data stored in the logical storage area of the first storage apparatus are migrated to the logical storage area of the second storage apparatus, transferring the storage tier construction information of the first storage apparatus to the second storage apparatus so as to reflect the construction of the storage tier in the logical storage area of the first storage apparatus in the second storage apparatus.

2. The storage system according to claim 1, wherein
the storage system holding pair configuration information storing a pair of the logical storage area of the first storage apparatus and the logical storage area of the second storage apparatus configured as a pair;
the storage system holding option information for determining allocation of the data to the storage tiers at a migration target of the data, the option information being applied to the pair configuration information when the data are migrated between the logical storage area of the first storage apparatus and the logical storage area of the second storage apparatus;
the data migration control unit determines a construction of the storage tier in the logical storage area of the second storage apparatus as a data migration target according to the option information attached to the pair configuration information for the first storage apparatus when the data stored in the logical storage area of the first storage apparatus are migrated to the logical storage area of the second storage apparatus.

3. The storage system according to claim 2, wherein
the storage tiers are ranked according to an access frequency from the external apparatus to the data stored in the logical storage are correlated to the storage tiers, and the data migration control part determines that the option information attached to the pair configuration information regarding the logical storage area of the first storage apparatus indicates the logical storage area is used for a data backup purpose for the data from the external apparatus using the logical storage area,
the data migration control part, when the data stored in the logical storage area of the first storage apparatus are migrated to the logical storage area of the second storage apparatus, stores the data into a storage tier ranked as a lowest level in the logical storage area of the second storage apparatus.

4. The storage system according to claim 2, wherein
the storage tiers are ranked according to an access frequency from the external apparatus to the data stored in the logical storage are correlated to the storage tiers, and when the data migration control part determines that the option information attached to the pair configuration information regarding the logical storage area of the first storage apparatus indicates the logical storage area is used for a data migration purpose for the data from the external apparatus using the logical storage area, the data migration control part, when the data stored in the logical storage area of the first storage apparatus are migrated to the logical storage area of the second storage apparatus, determines whether or not the logical storage area of the second storage apparatus has a storage tier corresponding to the storage tier of the logical storage area of the first storage apparatus, and, if determined the logical storage area of the second storage apparatus does not have a storage tier corresponding to the storage tier of the logical storage area of the first storage apparatus, the data migration control part stores the data into a storage tier of highest level among the storage areas ranked lower than the corresponding storage tier in the first storage apparatus.

5. The storage system according to claim 3, wherein
when the data stored for the data backup purpose in the logical storage area of the second storage apparatus are migrated back to the logical storage area of the first storage apparatus, the data migration control part transfers to the first storage apparatus the storage tier construction information received and held in itself from the first storage apparatus with the data, and
the data migration control part of the first storage apparatus stored the data from the second storage apparatus according to the storage tier configuration information as transferred.

6. The storage apparatus according to claim 4, wherein
the data migration control part of the first storage apparatus changes the storage tier construction information regarding the storage tier for the data in the logical storage area in response to a latest status of the storage tiers and transfers the storage tier construction information as changed to the second storage apparatus,
the data migration control part of the second storage apparatus, when the data migration control part of the second storage apparatus writes the data stored in the logical storage area of the second storage apparatus for a data migration purpose back to the first storage apparatus, transfers the storage tier construction information as changed transferred from the first storage apparatus back to the first storage apparatus, and
the data migration control part of the first storage apparatus stores the data as transferred into the logical storage area according to the changed storage tier construction information as transferred.

7. The storage apparatus according to claim 4, wherein
the storage system includes a third storage apparatus having a construction equivalent to the first storage apparatus and the second storage apparatus,
the data migration control part of the first storage apparatus changes the storage tier construction information regarding the storage tier for the data in the logical storage area in response to a latest status of the storage tiers and transfers the storage tier construction information as changed to the second storage apparatus,
the data migration control part of the second storage apparatus changes the storage tier construction information regarding the storage tier for the data in the logical storage area in response to a latest status of the storage tiers and transfers the storage tier construction information as changed to the third storage apparatus, and
the data migration control part of the third storage apparatus stores the data as transferred into the logical storage area according to the changed storage tier construction information as transferred.

8. The storage system according to claim 1, wherein
the storage system holds usage information that is information indicating a usage set for software operating in the external apparatus, the software using the logical storage area of one of the first storage apparatus and the second storage apparatus as a data storage area, and the data migration control part of one of the first storage apparatus and the second storage apparatus sets the option information according to the usage information as held.

9. A control method of a storage system, the storage system including
a first storage apparatus,
a second storage apparatus,
each of the first and second apparatuses including a logical storage area for storing data processed by an external apparatus,
each of the first and second apparatuses including a pool of a plurality of unit physical storage areas constructing a physical storage area for providing the logical storage area for storing the data;
the unit physical storage areas being classified into a plurality of storage tiers according to storage area property information for characterizing each of the unit physical storage areas;
the logical storage area in the first storage apparatus and the logical storage area in the second storage apparatus respectively including one or more of the storage tiers that are assigned to the respective logical storage areas according to the unit physical storage areas correlated to the respective logical storage areas;
the storage system holding storage tier construction information that is information of construction of the storage tier in the logical storage area of the first storage apparatus; and
the first storage apparatus, when the data stored in the logical storage area of the first storage apparatus are migrated to the logical storage area of the second storage apparatus, transferring the storage tier construction information of the first storage apparatus to the second storage apparatus so as to reflect the construction of the storage tier in the logical storage area of the first storage apparatus in the second storage apparatus.

10. The control method of the storage system according to claim 9, wherein
the storage system holds pair configuration information storing a pair of the logical storage area of the first storage apparatus and the logical storage area of the second storage apparatus configured as a pair;
the storage system holds option information for determining allocation of the data to the storage tiers at a migration target of the data, the option information being applied to the pair configuration information when the data are migrated between the logical storage area of the first storage apparatus and the logical storage area of the second storage apparatus;
the second storage apparatus determines a construction of the storage tier in the logical storage area of the second storage apparatus as a data migration target according to the option information attached to the pair configuration information for the first storage apparatus when the data stored in the logical storage area of the first storage apparatus are migrated to the logical storage area of the second storage apparatus.

11. The control method of the storage system according to claim 10, wherein
the storage tiers are ranked according to an access frequency from the external apparatus to the data stored in the logical storage area correlated to the storage tiers, and the data migration control part determines that the option information attached to the pair configuration information regarding the logical storage area of the first storage apparatus indicates the logical storage area is used for a data backup purpose for the data from the external apparatus using the logical storage area,
the second storage apparatus, when the data stored in the logical storage area of the first storage apparatus are migrated to the logical storage area of the second storage apparatus, stores the data into a storage tier ranked as a lowest level in the logical storage area of the second storage apparatus.

12. The control method of the storage system according to claim 10, wherein
the storage tiers are ranked according to an access frequency from the external apparatus to the data stored in the logical storage are correlated to the storage tiers, and when the data migration control part determines that the option information attached to the pair configuration information regarding the logical storage area of the first storage apparatus indicates the logical storage area is used for a data migration purpose for the data from the external apparatus using the logical storage area,
the second storage apparatus, when the data stored in the logical storage area of the first storage apparatus are migrated to the logical storage area of the second storage apparatus, determines whether or not the logical storage area of the second storage apparatus has a storage tier corresponding to the storage tier of the logical storage area of the first storage apparatus, and, if determined the logical storage area of the second storage apparatus does not have a storage tier corresponding to the storage tier of the logical storage area of the first storage apparatus, the data migration control part stores the data into a storage tier of highest level among the storage areas ranked lower than the corresponding storage tier in the first storage apparatus.

13. The control method of the storage system according to claim 11, wherein
when the data stored for the data backup purpose in the logical storage area of the second storage apparatus are migrated back to the logical storage area of the first storage apparatus, the second storage apparatus transfers to the first storage apparatus the storage tier construction information received and held in itself from the first storage apparatus with the data, and
the first storage apparatus stores the data from the second storage apparatus according to the storage tier configuration information as transferred.

14. The control method of the storage apparatus according to claim 12, wherein
the first storage apparatus changes the storage tier construction information regarding the storage tier for the data in the logical storage area in response to a latest status of the storage tiers and transfers the storage tier construction information as changed to the second storage apparatus,
the second storage apparatus, when the data migration control part of the second storage apparatus writes the data stored in the logical storage area of the second storage apparatus for a data migration purpose back to the first storage apparatus, transfers the storage tier construction information as changed transferred from the first storage apparatus back to the first storage apparatus, and
the first storage apparatus stores the data as transferred into the logical storage area according to the changed storage tier construction information as transferred.

15. The control method of the storage apparatus according to claim 12, wherein
the storage system includes a third storage apparatus having a construction equivalent to the first storage apparatus and the second storage apparatus,
the first storage apparatus changes the storage tier construction information regarding the storage tier for the data in the logical storage area in response to a latest status of the storage tiers and transfers the storage tier construction information as changed to the second storage apparatus,
the second storage apparatus changes the storage tier construction information regarding the storage tier for the data in the logical storage area in response to a latest status of the storage tiers and transfers the storage tier construction information as changed to the third storage apparatus, and
the third storage apparatus stores the data as transferred into the logical storage area according to the changed storage tier construction information as transferred.
